(19) United States
(12) Patent Application Publication
(10) Pub. No.: US 2022/0007423 A1
(43) Pub. Date: Jan. 6, 2022

(54) METHOD AND APPARATUS FOR SMALL DATA TRANSMISSION

(71) Applicant: Samsung Electronics Co., Ltd., Suwon-si (KR)

(72) Inventor: Anil Agiwal, Suwon-si (KR)

(21) Appl. No.: 17/368,229

(22) Filed: Jul. 6, 2021

(30) Foreign Application Priority Data
Jul. 6, 2020 (KR) 10-2020-0082892

(51) Int. Cl. H04W 74/08; H04W 76/27

(52) U.S. Cl. CPC H04W 74/0833; G16Y 30/00; H04W 76/27

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The present disclosure provides method and apparatus for small data transmission.

### CROSS-REFERENCE TO RELATED APPLICATION(S)

This application is based on and claims priority under 35 U.S.C. § 119(a) of a Korean patent application number 10-2020-0082892, filed on Jul. 6, 2020, in the Korean Intellectual Property Office, the disclosure of which is incorporated by reference herein in its entirety.

### BACKGROUND

### 1. Field

The disclosure relates to a wireless communication system. More particularly, the disclosure relates to an apparatus, a method and a system for small data transmission in a wireless communication system. Also, the disclosure relates to an apparatus, a method, and a system for a random access (RA) procedure for large propagation delays in a wireless communication system.

### 2. Description of Related Art

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a ‘Beyond 4G Network’ or a ‘Post long term evolution (LTE) System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, analog beam forming, and large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation, and the like. In the 5G system, Hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as advanced access technologies have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology,” “wired/wireless communication and network infrastructure,” “service interface technology,” and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud Radio Access Network (RAN) as the above-described Big Data processing technology may also be considered to be as an example of convergence between the 5G technology and the IoT technology.

Meanwhile, there have been various studies on small data transmission (SDT) in 5G communication systems recently.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G) communication system.

Additional aspects will be set forth in part in the description which follows and, in part, will be apparent from the description, or may be learned by practice of the presented embodiments.

In accordance with an aspect of the disclosure, a method performed by a terminal is provided. The method includes identifying that a small data transmission (SDT) procedure is initiated based on an uplink data of a radio bearer for which an SDT is allowed; transmitting, to a base station while in a radio resource control (RRC) inactive state, the uplink data, wherein the uplink data is integrity protected using an integrity key generated based on the initiation of the SDT procedure; and receiving, from the base station, an RRC release message for terminating the SDT procedure.

In accordance with another aspect of the disclosure, a method performed by a base station is provided. The method includes receiving, from a terminal in an RRC inactive state, uplink data of a radio bearer for which an SDT is allowed, wherein the uplink data is integrity protected using an integrity key generated based on an initiation of an SDT procedure; and transmitting, to the terminal, an RRC release message for terminating the SDT procedure.

In accordance with another aspect of the disclosure, a terminal is provided. The terminal includes a transceiver configured to transmit and receive a signal; and a controller coupled with the transceiver and configured to: identify that an SDT procedure is initiated based on an uplink data of a radio bearer for which an SDT is allowed, transmit, to a base station while in an RRC inactive state, the uplink data, wherein the uplink data is integrity protected using a integrity key generated based on the initiation of the SDT procedure, and receive, from the base station, an RRC release message for terminating the SDT procedure.

In accordance with another aspect of the disclosure, a base station is provided. The base station includes a transceiver configured to transmit and receive a signal; and a controller coupled with the transceiver and configured to: receive, from a terminal in an RRC inactive state, uplink data of a radio bearer for which an SDT is allowed, wherein the uplink data is integrity protected using a integrity key generated based on an initiation of an SDT procedure, and transmit, to the terminal, an RRC release message for terminating the SDT procedure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a preamble receiving window in non-terrestrial network (NTN) according to an embodiment of the disclosure;

FIG. 2 illustrates an example of ambiguity problem on preamble reception according to an embodiment of the disclosure;

FIG. 3 illustrates an example of physical random access (RA) channel (PRACH) occasions according to an embodiment of the disclosure;

FIG. 4 illustrates another example of PRACH occasions according to an embodiment of the disclosure;

FIG. 5 illustrates an example of a signaling flow between terminal and base station according to an embodiment of the disclosure;

FIG. 6 illustrates another example of PRACH occasions according to an embodiment of the disclosure;

FIG. 7 illustrates an example of signaling flow for small data transmission according to an embodiment of the disclosure;

FIG. 8 illustrates another example of signaling flow for small data transmission according to an embodiment of the disclosure;

FIG. 9 illustrates another example of signaling flow for small data transmission according to an embodiment of the disclosure;

FIG. 10 illustrates another example of signaling flow for small data transmission according to an embodiment of the disclosure;

FIG. 11 is a block diagram of a terminal according to an embodiment of the disclosure; and

FIG. 12 is a block diagram of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit,” “module” or the like may refer to a software component or hardware component, such as, for example, a field-programmable gate array (FPGA) or an application-specific integrated circuit (ASIC) capable of carrying out a function or an operation. However, a “unit,” or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), fifth generation (5G) NB (5GNB), or next generation node B (gNB).

The “UE” is an entity communicating with a BS and may be referred to as UE, device, mobile station (MS), mobile equipment (ME), or terminal.

In the recent years several broadband wireless technologies have been developed to meet the growing number of broadband subscribers and to provide more and better applications and services. The second generation (2G) wireless communication system has been developed to provide voice services while ensuring the mobility of users. Third generation (3G) wireless communication system supports not only the voice service but also data service. In recent years, the fourth wireless communication system has been developed to provide high-speed data service. However, currently, the fourth generation (4G) wireless communication system suffers from lack of resources to meet the growing demand for high speed data services. So the 5G wireless communication system is being developed to meet the growing demand for high speed data services, ultra-reliability, and low latency applications.

The 5G wireless communication system will be implemented not only in lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, analog beam forming, and large scale antenna techniques are being considered in the design of the 5G wireless communication system. In addition, the 5G wireless communication system is expected to address different use cases having quite different requirements in terms of data rate, latency, reliability, mobility etc. However, it is expected that the design of the air-interface of the 5G wireless communication system would be flexible enough to serve the UEs having quite different capabilities depending on the use case and market segment the UE cater service to the end customer. Few examples use cases the 5G wireless communication system wireless system is expected to address is enhanced Mobile Broadband (eMBB), massive Machine Type Communication (m-MTC), ultra-reliable low latency communication (URLL), etc. The eMBB requirements such as tens of Gbps data rate, low latency, high mobility, etc. address the market segment representing the wireless broadband subscribers needing constant internet connectivity everywhere. The m-MTC requirements such as very high connection density, infrequent data transmission, very long battery life, low mobility address, etc. address the market segment representing the Internet of Things (IoT)/Internet of Everything (IoE) envisioning connectivity of billions of devices. The URLL requirements such as very low latency, very high reliability and variable mobility so on and so forth address the market segment representing the Industrial automation application, with vehicle-to-vehicle/vehicle-to-infrastructure communication foreseen as a requirement for autonomous cars.

In the 5G wireless communication system operating in higher frequency (mmWave) bands, UE and gNB communicates with each other using Beamforming Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas.

In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal.

By using beamforming technique, a transmitter can make plurality of transmit beam patterns of different directions. Each of these transmit beam patterns can be also referred as a TX beam. A wireless communication system operating at high frequency uses a plurality of narrow TX beams to transmit signals in the cell as each narrow TX beam provides coverage to a part of cell. The narrower the TX beam, the higher the antenna gain is, and hence the larger the propagation distance of a signal transmitted using beamforming A receiver can also make a plurality of RX beam patterns of different directions. Each of these receive patterns can be also referred as an RX beam.

The 5G wireless communication system (also referred as next generation radio or NR), supports a standalone mode of operation as well dual connectivity (DC). In DC a multiple RX/TX UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-radio access technology (RAT) Dual Connectivity (MR-DC) operation whereby a UE in radio resource control connected (RRC_CONNECTED) is configured to utilize radio resources provided by two distinct schedulers, located in two different nodes connected via a non-ideal backhaul and providing either Evolved Universal Mobile Telecommunications System (UMTS) Terrestrial Radio Access (E-UTRA) (i.e., if the node is a gNB) or NR access (i.e. if the node is a gNB). In NR for a UE in RRC_CONNECTED not configured with carrier aggregation (CA)/DC there is only one serving cell comprising the primary cell. For a UE in RRC_CONNECTED configured with CA/DC the term ‘serving cells’ is used to denote the set of cells comprising Special Cell(s) and all secondary cells. In NR the term Master Cell Group (MCG) refers to a group of serving cells associated with the Master Node, comprising the Primary Cell (PCell) and optionally one or more Secondary Cells (SCells). In NR the term Secondary Cell Group (SCG) refers to a group of serving cells associated with the Secondary Node, comprising of the Primary SCG Cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, S cell is a cell providing additional radio resources on top of Special Cell. PSCell refers to a serving cell in an SCG in which the UE performs random access (RA) when performing the Reconfiguration with Sync procedure. For Dual Connectivity operation the term Special Cell (SpCell) refers to the PCell of the MCG or the PSCell of the SCG, otherwise the term Special Cell refers to the PCell.

In the 5G wireless communication system (or NR), a Physical Downlink Control Channel (PDCCH) is used to schedule downlink (DL) transmissions on a Physical Downlink Shared Channel (PDSCH) and uplink (UL) transmissions on a Physical Uplink Shared Channel (PUSCH), where Downlink Control Information (DCI) on the PDCCH includes: Downlink assignments containing at least modulation and coding format, resource allocation, and hybrid automatic repeat request (HARQ) information related to a downlink shared channel (DL-SCH); Uplink scheduling grants containing at least modulation and coding format, resource allocation, and hybrid-ARQ information related to an uplink shared channel (UL-SCH). In addition to scheduling, a PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB(s)) and orthogonal frequency division multiplexing (OFDM) symbol(s) where the UE may assume no transmission is intended for the UE; transmission of transmission power control (TPC) commands for a Physical Uplink Control Channel (PUCCH) and PUSCH; transmission of one or more TPC commands for sounding reference signal (SRS) transmissions by one or more UEs; switching a UE's active bandwidth part; or initiating a RA procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In NR, a list of search space configurations is signaled by a gNB for each configured bandwidth part (BWP) wherein each search configuration is uniquely identified by an identifier. Identifier of search space configuration to be used for specific purpose such as paging reception, system information (SI) reception, RA response (RAR) reception is explicitly signaled by a gNB. In NR search space, configuration comprises of parameters Monitoring-periodicity-PDCCH-slot, Monitoring-offset-PDCCH-slot, Monitoring-symbols-PDCCH-within-slot, and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration, where the slot with number ‘x’ in a radio frame with number ‘y’ satisfies the Equation 1 below:

(y*(number of slots in a radio frame)+x−Monitoring-offset-PDCCH-slot)mod(Monitoring-periodicity-PDCCH-slot)=0 Equation 1

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. Search space configuration includes the identifier of a CORESET configuration associated with it. A list of CORESET configurations is signaled by a gNB for each configured BWP, wherein each CORESET configuration is uniquely identified by an identifier. Note that each radio frame is of 10 ms duration. A radio frame is identified by a radio frame number or system frame number. Each radio frame comprises several slots, wherein the number of slots in a radio frame and duration of slots depends on a sub carrier spacing. The number of slots in a radio frame and duration of slots depends on a radio frame for each supported subcarrier spacing (SCS), and is pre-defined in NR. Each CORESET configuration is associated with a list of transmission configuration indicator (TCI) states. One DL reference signal (RS) identifier (ID) (e.g., a synchronization signal block (SSB) or channel state information reference signal (CSI-RS)) is configured per TCI state. The list of TCI states corresponding to a CORESET configuration is signaled by the gNB via RRC signaling. One of the TCI states in TCI state list is activated and indicated to the UE by the gNB. The TCI state indicates the DL TX beam (DL TX beam is quasi-collocated (QCLed) with SSB/CSI RS of TCI state) used by gNB for transmission of PDCCH in the PDCCH monitoring occasions of a search space.

In NR, bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP).

BA is achieved by configuring an RRC connected UE with BWP(s) and telling the UE which of the configured BWPs is currently the active one. When BA is configured, the UE only has to monitor PDCCH on the one active BWP, i.e., it does not have to monitor PDCCH on the entire DL frequency of the serving cell. In the RRC connected state, the UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the BWP-InactivityTimer, by RRC signaling, or by the medium access control (MAC) entity itself upon initiation of an RA procedure. Upon addition of an SpCell or activation of an SCell, the DL BWP and UL BWP indicated by firstActiveDownlinkBWP-Id and firstActiveUplinkBWP-Id respectively are active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of a BWP inactivity timer the UE switches the active DL BWP to the default DL BWP or an initial DL BWP (if the default DL BWP is not configured).

In the 5G wireless communication system, RA is supported. RA is used to UL time synchronization. RA is used during initial access, handover, RRC connection re-establishment procedure, scheduling request transmission, SCG addition/modification, beam failure recovery and data or control information transmission in UL by a non-synchronized UE in RRC CONNECTED state. Several types of RA procedure are supported.

Contention based RA (CBRA): This is also referred as 4 step CBRA. In this type of random access, a UE first transmits an RA preamble (also referred as Msg1) and then waits for an RA response (RAR) in the RAR window. RAR is also referred as Msg2. A gNB transmits the RAR on a PDSCH. A PDCCH scheduling the PDSCH carrying RAR is addressed to an RA-radio network temporary identifier (RA-RNTI). The RA-RNTI identifies the time-frequency resource (also referred as physical RA channel (PRACH) occasion or PRACH transmission (TX) occasion or RA channel (RACH) occasion) in which an RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., the RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various RA preambles detected by the gNB can be multiplexed in the same RAR MAC protocol data unit (PDU) by the gNB. An RAR in a MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in RACH configuration) number of times, the UE goes back to the first step, i.e., select RA resource (preamble/RACH occasion (RO)), and transmits the RA preamble. A backoff may be applied before going back to first step.

If the RAR corresponding to its RA preamble transmission is received the UE transmits message 3 (Msg3) in an UL grant received in RAR. Msg3 includes messages such as an RRC connection request, an RRC connection re-establishment request, an RRC handover confirm, a scheduling request, an SI request, etc. It may include the UE identity (i.e., a cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a PDCCH addressed to the C-RNTI included in Msg3, contention resolution is considered successful, the contention resolution timer is stopped, and the RA procedure is completed. While the contention resolution timer is running, if the UE receives a contention resolution MAC control element (CE) including the UE's contention resolution identity (e.g., first X bits of a common control channel (CCCH) service data unit (SDU) transmitted in Msg3), contention resolution is considered successful, the contention resolution timer is stopped, and the RA procedure is completed. If the contention resolution timer expires and the UE has not yet transmitted the RA preamble for a configurable number of times, the UE goes back to the first step, i.e., select RA resource (preamble/RACH occasion), and transmits the RA preamble. A backoff may be applied before going back to the first step.

Contention free RA (CFRA): This is also referred as legacy CFRA or 4 step CFRA. CFRA procedure is used for scenarios such as handover where low latency is required, timing advance establishment for SCell, etc. An eNB assigns to the UE a dedicated RA preamble. The UE transmits the dedicated RA preamble. The eNB transmits the RAR on a PDSCH addressed to an RA-RNTI. The RAR conveys the RA preamble identifier and timing alignment information. The RAR may also include a UL grant. The RAR is transmitted in an RAR window similar to a CBRA procedure. CFRA is considered successfully completed after receiving the RAR including a RAPID of the RA preamble transmitted by the UE. In case RA is initiated for beam failure recovery, CFRA is considered successfully completed if a PDCCH addressed to a C-RNTI is received in a search space for beam failure recovery. If the RAR window expires and RA is not successfully completed and the UE has not yet transmitted the RA preamble for a configurable (configured by the gNB in RACH configuration) number of times, the UE retransmits the RA preamble.

For certain events such has handover and beam failure recovery if dedicated preamble(s) are assigned to the UE, during the first step of random access, i.e., during RA resource selection for Msg1 transmission, the UE determines whether to transmit a dedicated preamble or a non-dedicated preamble. Dedicated preambles are typically provided for a subset of SSBs/CSI-RSs. If there is no SSB/CSI-RS having a DL reference signal received power (RSRP) above a threshold amongst the SSBs/CSI-RSs for which contention free RA resources (i.e., dedicated preambles/ROs) are provided by gNB, the UE selects a non-dedicated preamble. Otherwise, the UE selects a dedicated preamble. During the RA procedure, one RA attempt can be CFRA while another RA attempt can be CBRA.

2 step contention based RA (2 step CBRA): In the first step, the UE transmits the RA preamble on a PRACH and a payload (i.e., a MAC PDU) on a PUSCH. The RA preamble and payload transmission is also referred as MsgA. In the second step, after MsgA transmission, the UE monitors for a response from the network (i.e., the gNB) within a configured window. The response is also referred as MsgB. If a CCCH SDU was transmitted in the MsgA payload, the UE performs contention resolution using the contention resolution information in MsgB. The contention resolution is successful if the contention resolution identity received in MsgB matches first 48 bits of the CCCH SDU transmitted in MsgA. If a C-RNTI was transmitted in the MsgA payload, the contention resolution is successful if the UE receives the PDCCH addressed to C-RNTI. If contention resolution is successful, the RA procedure is considered successfully completed. Instead of contention resolution information corresponding to the transmitted MsgA, MsgB may include fallback information corresponding to the RA preamble transmitted in MsgA. If the fallback information is received, the UE transmits Msg3 and performs contention resolution using Msg4 as in the CBRA procedure. If contention resolution is successful, the RA procedure is considered successfully completed. If contention resolution fails upon fallback (i.e., upon transmitting Msg3), the UE retransmits MsgA. If a configured window in which the UE monitors network response after transmitting MsgA expires and the UE has not received MsgB including contention resolution information or fallback information as above, the UE retransmits MsgA. If the RA procedure is not successfully completed even after transmitting the MsgA configurable number of times, the UE fallbacks to the 4 step RACH procedure, i.e., the UE only transmits the PRACH preamble.

MsgA payload may include one or more of a CCCH SDU, a dedicated control channel (DCCH) SDU, a dedicated traffic channel (DTCH) SDU, a buffer status report (BSR) MAC control element (CE), a power headroom report (PHR) MAC CE, SSB information, a C-RNTI MAC CE, or padding. MsgA may include a UE ID (e.g., a random ID, an S-TMSI, a C-RNTI, a resume ID, etc.) along with the preamble in the first step. The UE ID may be included in the MAC PDU of the MsgA. A UE ID such as a C-RNTI may be carried in the MAC CE wherein the MAC CE is included in the MAC PDU. Other UE IDs (such as random ID, an S-TMSI, a C-RNTI, a resume ID, etc.) may be carried in a CCCH SDU. The UE ID can be one of a random ID, an S-TMSI, a C-RNTI, a resume ID, an international mobile subscriber identity (IMSI), an idle mode ID, an inactive mode ID, etc. The UE ID can be different in different scenarios in which the UE performs the RA procedure. When the UE performs RA after power on (before it is attached to the network), then the UE ID is the random ID. When the UE performs RA in an IDLE state after it is attached to network, the UE ID is the S-TMSI. If the UE has an assigned C-RNTI (e.g., in connected state), the UE ID is the C-RNTI. In case the UE is in INACTIVE state, the UE ID is the resume ID. In addition to the UE ID, some addition control information can be sent in MsgA. The control information may be included in the MAC PDU of the MsgA. The control information may include one or more of a connection request indication, a connection resume request indication, a system information (SI) request indication, a buffer status indication, beam information (e.g., one or more DL TX beam ID(s) or SSB ID(s)), beam failure recovery indication/information, a data indicator, a cell/BS/TRP switching indication, a connection re-establishment indication, a reconfiguration complete or handover complete message, etc.

2 step contention free RA (2 step CFRA): In this case the gNB assigns to the UE dedicated RA preamble(s) and PUSCH resource(s) for MsgA transmission. RO(s) to be used for preamble transmission may also be indicated. In the first step, the UE transmits the RA preamble on a PRACH and a payload on a PUSCH using the contention free RA resources (i.e., a dedicated preamble/PUSCH resource/RO). In the second step, after MsgA transmission, the UE monitors for a response from the network (i.e., the gNB) within a configured window. If the UE receives a PDCCH addressed to a C-RNTI, the RA procedure is considered successfully completed. If the UE receives fallback information corresponding to its transmitted preamble, the RA procedure is considered successfully completed.

For certain events such has handover and beam failure recovery if dedicated preamble(s) and PUSCH resource(s) are assigned to the UE, during the first step of random access, i.e., during RA resource selection for MsgA transmission the UE determines whether to transmit a dedicated preamble or a non-dedicated preamble. Dedicated preambles are typically provided for a subset of SSBs/CSI-RSs. If there is no SSB/CSI-RS having a DL RSRP above a threshold amongst the SSBs/CSI-RSs for which contention free RA resources (i.e., dedicated preambles/ROs/PUSCH resources) are provided by the gNB, the UE selects a non dedicated preamble. Otherwise, the UE selects a dedicated preamble. During the RA procedure, one RA attempt can be 2 step CFRA while another RA attempt can be 2 step CBRA.

Upon initiation of RA procedure, the UE first selects the carrier (SUL or NUL). If the carrier to use for the RA procedure is explicitly signaled by the gNB, the UE selects the signaled carrier for performing the RA procedure. If the carrier to use for the RA procedure is not explicitly signaled by the gNB, and if the Serving Cell for the RA procedure is configured with supplementary uplink and if the RSRP of the downlink path loss reference is less than rsrp-ThresholdSSB-SUL, the UE selects the SUL carrier for performing the RA procedure. Otherwise, the UE selects the NUL carrier for performing the RA procedure. Upon selecting the UL carrier, the UE determines the UL and DL BWP for the RA procedure as specified in section 5.15 of TS 38.321. The UE then determines whether to perform 2 step or 4 step RACH for this RA procedure.
If this RA procedure is initiated by a PDCCH order and if the RA-PreambleIndex explicitly provided by the PDCCH is not 0b000000, the UE selects 4 step RACH;
else if 2 step contention free RA resources are signaled by the gNB for this RA procedure, the UE selects 2 step RACH;
else if 4 step contention free RA resources are signaled by the gNB for this RA procedure, the UE selects 4 step RACH;
else if the UL BWP selected for this RA procedure is configured with only 2 step RACH resources, the UE selects 2 step RACH;
else if the UL BWP selected for this RA procedure is configured with only 4 step RACH resources, the UE selects 4 step RACH;
else if the UL BWP selected for this RA procedure is configured with both 2 step and 4 step RACH resources;
else if an RSRP of the downlink path loss reference is below a configured threshold, the UE selects 4 step RACH. Otherwise, the UE selects 2 step RACH.

### Embodiment 1—PRACH Occasion Configuration

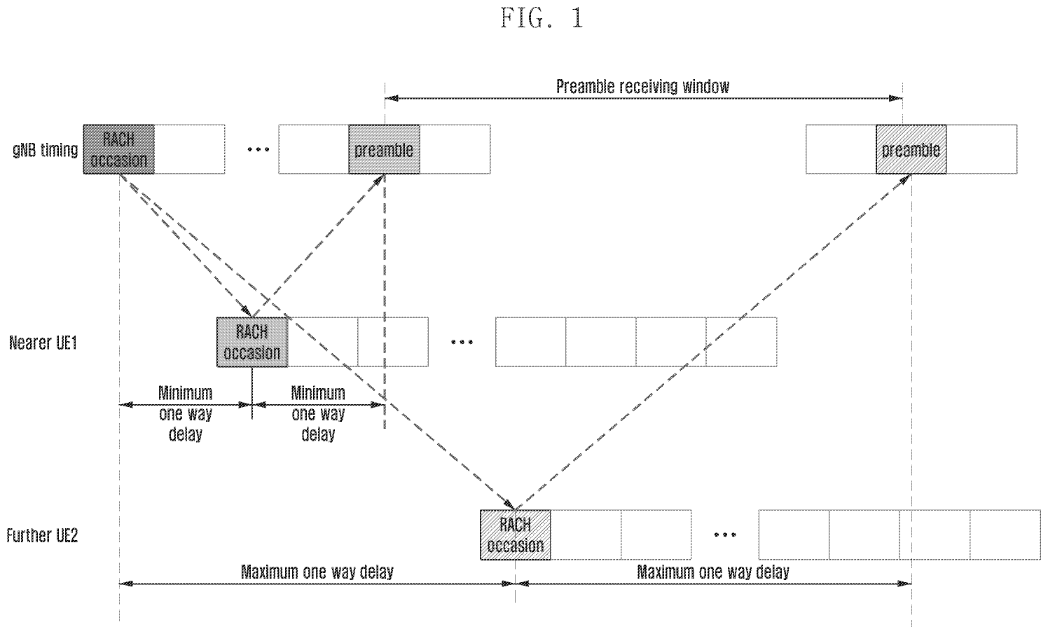

FIG. 1 illustrates a preamble receiving window in non-terrestrial network (NTN) according to an embodiment of the disclosure.

The 5G wireless communication system supports non terrestrial networks (NTN) wherein the base station can be on board a satellite or the base station is on ground but the communication between the UE and the base station is relayed by satellite. In NTN, the maximum and minimum propagation delay can be in 10 s of milliseconds depending on a type (geostationary orbit (GEO), low earth orbit (LEO), medium earth orbit (MEO), high altitude platform station system (HAPS), etc.) of the satellite. In NTN, differential delay could be experienced by two UEs within the same cell. As a result, the preambles sent by different UEs in the same RO may reach the network at different time.

Referring to FIG. 1, to ensure the network can receive preambles from all the UEs, the preamble receiving window should start from [RO timing+minimum one-way delay*2] and end with [RO timing+maximum one-way delay*2].

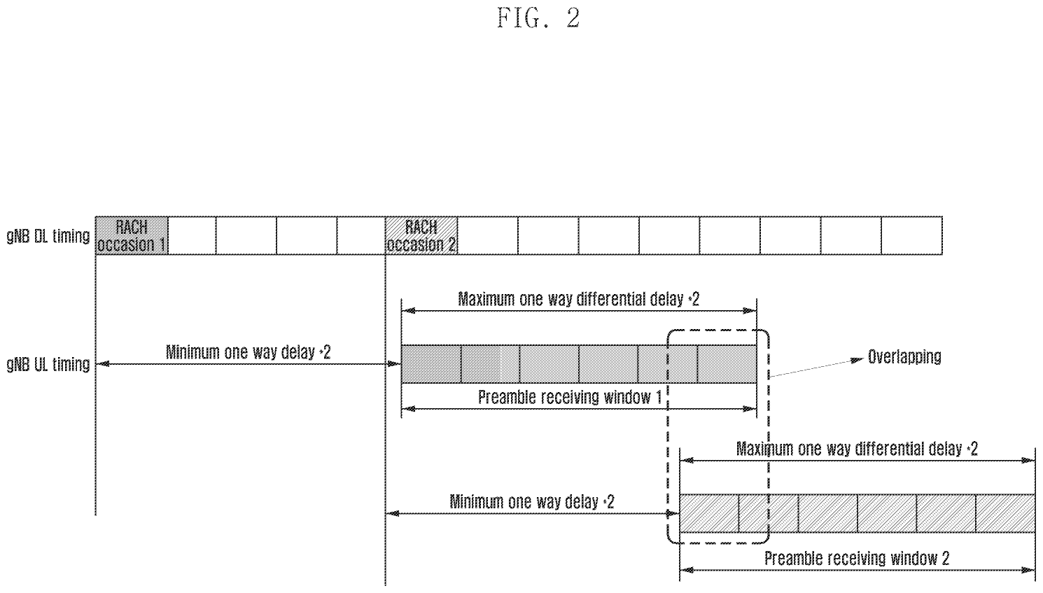

FIG. 2 illustrates an example of ambiguity problem on preamble reception according to an embodiment of the disclosure.

When a preamble is received, the network needs to know which RO the preamble is related to in order to estimate the accurate timing advance.

Referring to FIG. 2, if the RO periodicity is not long enough, the preamble receiving windows for two consecutive ROs may be overlapped with each other, making it difficult for the network to link the received preamble to the corresponding RO.

For a typical GEO satellite cell in a 1000 km orbit, the time interval between two consecutive ROs should be larger than 6.44 ms (equivalent to two times the maximum delay difference) to avoid the above issue. For a typical GEO satellite cell in a 500 km orbit, the time interval between two consecutive ROs should be larger than 3.26 ms to avoid the above issue. The ambiguity of preamble reception can be avoided by proper configuration of RACH resources (i.e., RACH occasions), in which case the time interval between two consecutive ROs is larger than the maximum delay difference*2 within the cell. However, this approach reduces the RACH resources and thus impacts the supported UE density in the cell.

### Embodiment 1-1

In the current design for RA preamble transmission (in case of 4 step RA procedure or 2 step RA procedure) a set of PRACH occasions occurs every PRACH configuration period. The time domain occurrence of these PRACH occasions is signaled to the UE by a parameter PRACH configuration index. A list of PRACH configurations indicating PRACH occasions in a time domain is pre-defined. The PRACH configuration index identifies one PRACH configuration in the list (i.e., it is an index to a row in a pre-defined table of a list of PRACH configurations). For each instance of a PRACH occasion in the time domain, multiple PRACH occasions can be configured in a frequency domain. The starting offset of the first PRACH occasion among each set of frequency division multiplexed (FDMed) PRACH occasions with respect to physical resource block (PRB) 0 of UL BWP is signaled by the gNB. The second PRACH occasion among each set of FDMed PRACH occasions starts from the end of first PRACH occasion, the third PRACH occasion among each set of FDMed PRACH occasions starts from the end of the second PRACH occasion, and so on (i.e., the ‘n’-th PRACH occasion amongst each set of FDMed PRACH occasions starts from the end of the ‘n−1’-th PRACH occasion, where n=1, 2, . . . , number of FDMed PRACH occasions). The number of PRBs occupied by each PRACH occasion is also configured or can be pre-defined for difference PRACH sequence lengths.

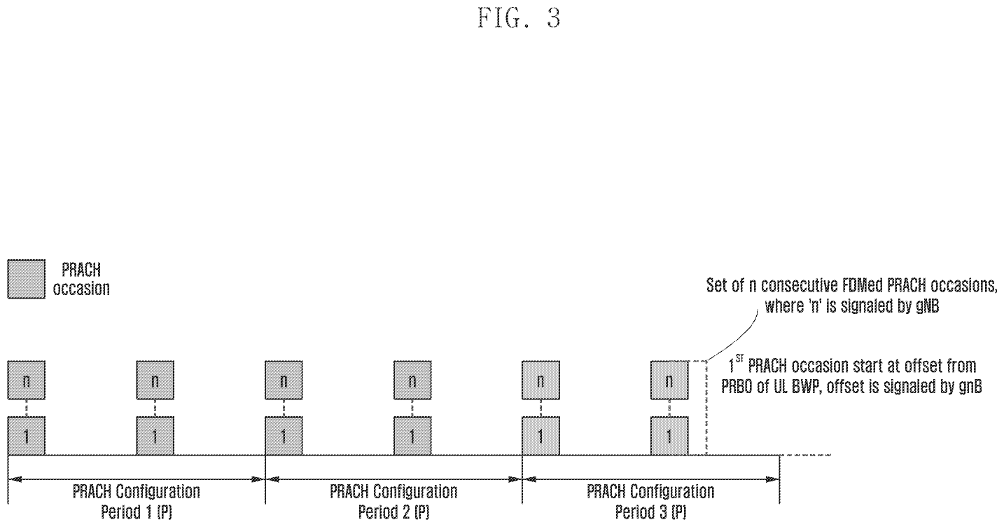

FIG. 3 illustrates an example of PRACH occasions according to an embodiment of the disclosure. In this example, there are two occurrences of PRACH occasions in the time domain every PRACH configuration period. Each occurrence consists of ‘n’ FDMed PRACH occasions (‘n’ can be 1 as well). If the size of each PRACH occasion is ‘x’ PRBs, each set of FDMed PRACH occasions occupies x*n consecutive PRBs starting from a PRB which starts at an offset from PRB 0 of the UL BWP, where the offset is signaled in the RACH configuration.

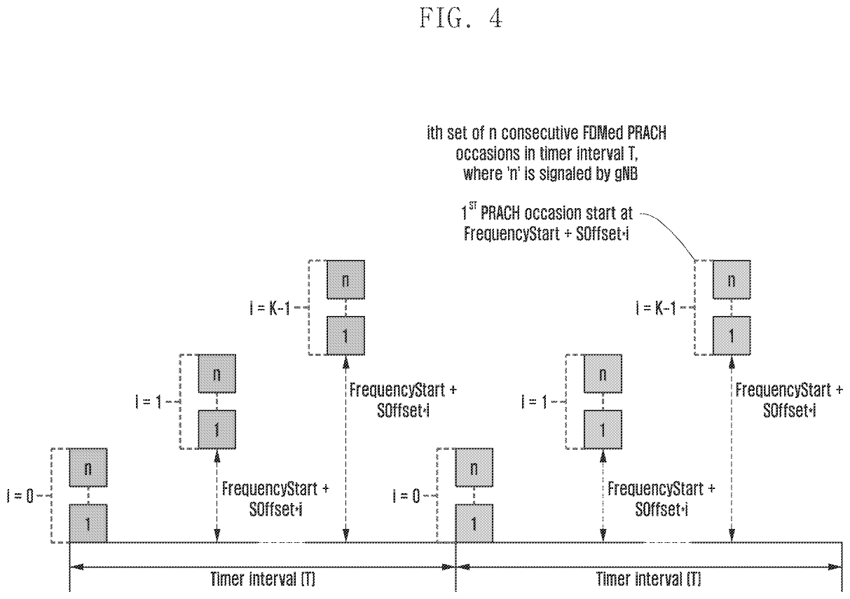

FIG. 4 illustrates another example of PRACH occasions according to an embodiment of the disclosure.

In one method of this disclosure, each set of ‘n’ FDMed PRACH occasions every interval ‘T’ are allocated to different PRBs (‘n’ is configurable and can be 1). The first interval T starts from the start of the first PRACH configuration period. Sets of FDMed ROs in every interval ‘T’ are sequentially indexed from 0. The 1st PRACH occasion of the i-th set of FDMed PRACH occasions in interval ‘T’ starts from a PRB given by FrequencyStart+S Offset*i, where FrequencyStart is the offset with respect to PRB 0 of the UL BWP and is signaled by the gNB; ‘SOffset’ can be signaled by the gNB. Alternately, SOffset=Number of FDMed PRACH occasions*number of PRBs per PRACH occasion. The number of FDMed PRACH occasions is signaled by the gNB. In an embodiment, the timer interval T is equal to 2*maximum delay difference in cell. Maximum delay difference=Maximum propagation delay−minimum propagation delay. The time interval T or maximum delay difference can be signaled by the gNB in system information (i.e., in a system information block (SIB)) or dedicated RRC signaling. Alternately, the maximum propagation delay and minimum propagation delay can be signaled by the gNB in system information (i.e., an SIB) or dedicated RRC signaling. In an embodiment, the timer interval T can be signaled in units of the PRACH configuration period. In an embodiment, instead of signaling the time interval T in units of the PRACH configuration period, a parameter ‘m’ can be signaled, where ‘m’ is the number of sets of FDMed PRACH occasions in the timer interval T.

In an embodiment, invalid PRACH occasions from the PRACH occasions indicated by PRACH configuration index can be removed before applying the above rule to determine the FDMed PRACH occasions. For paired spectrum, all PRACH occasions are valid. For unpaired spectrum,
if a UE is not provided tdd-UL-DL-ConfigurationCommon (where tdd-UL-DL-ConfigurationCommon is signaled by the gNB in system information or dedicated RRC signaling message), a PRACH occasion in a PRACH slot is valid if it does not precede a synchronization signals (SS) and physical broadcast channel (PBCH) (SS/PBCH) block in the PRACH slot and starts at least N_gap symbols after a last SS/PBCH block reception symbol, where N_gap is 0 for a 1.25 kHz or 5 kHz preamble SCS and 2 for a 15 kHz or 30 kHz or 60 kHz or 120 kHz preamble SCS.
   the index of the SS/PBCH block (SSB) is provided by ssb-PositionsInBurst in SIB1 or in ServingCellConfigCommon
If a UE is provided tdd-UL-DL-ConfigurationCommon, a PRACH occasion in a PRACH slot is valid if:
   it is within UL symbols, or
   it does not precede a SS/PBCH block in the PRACH slot and starts at least N_gap symbols after a last downlink symbol and at least N_gap symbols after a last SS/PBCH block symbol, where N_gap is 0 for a 1.25 kHz or 5 kHz preamble SCS and 2 for a 15 kHz or 30 kHz or 60 kHz or 120 kHz preamble SCS.
      the index of the SS/PBCH block is provided by ssb-PositionsInBurst in SIB1 or in ServingCellConfigCommon.

In this embodiment, if the PRACH occasions are separated by less than 2*maximum delay difference, these PRACH occasions can be overlapped in time but not in the frequency domain. As a result, even if receiving windows of these PRACH occasions overlap, the gNB can still identify the associated RACH occasion for a detected preamble based on the frequency domain location of the PRACH occasion in which the preamble is received. For example, RACH occasion 1 and RACH occasion 2 in FIG. 2, occupy PRB0 to PRB5 and PRB6 to PRB 11, respectively. In the overlapped region of receiving window, if preamble is detected in PRB0 to PRB5, the preamble is associated with RACH occasion 1; if preamble is detected in PRB6 to PRB11, the preamble is associated with RACH occasion 2.

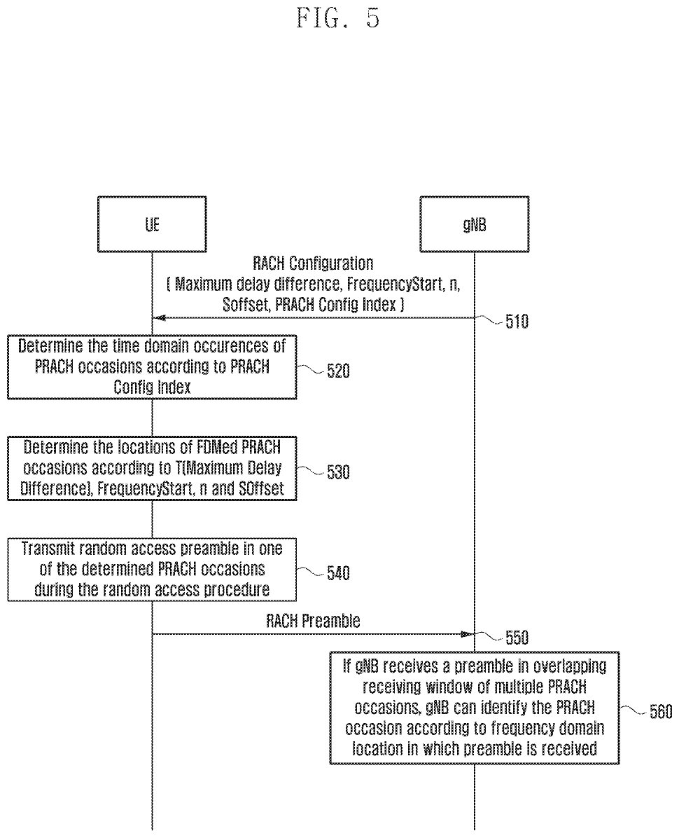

FIG. 5 illustrates an example of a signaling flow between a terminal (i.e., a UE) and a base station according to an embodiment of the disclosure. The UE receives the RACH configuration from gNB at operation 510. The UE determines the time domain occurrences of the PRACH occasions according to the PRACH Configuration Index at operation 520. The UE determines the locations of FDMed PRACH occasions according to T (Maximum Delay Difference), FrequencyStart, n, and SOffset as explained earlier, at operation 530. The UE determines the association between the preambles and SSBs and PRACH occasions and SSBs. During the RA procedure, the UE selects the SSB; the UE selects a preamble corresponding to selected SSB; the UE selects PRACH occasions from one of the determined PRACH occasions corresponding to selected SSB. The UE transmits the selected RA preamble in a selected PRACH occasion at operation 540. If the gNB receives a preamble in overlapping receiving windows of multiple PRACH occasions at operation 550, the gNB can identify the PRACH occasion according to the frequency domain location in which preamble is received at operation 560.

### Embodiment 1-2

In the current embodiment, RA preambles and PRACH occasions are mapped to SSBs as follows: For the 4 step RA procedure (also referred as Type 1), a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB.

For the 4 step RA procedure, if N<1, one SS/PBCH block is mapped to 1/N consecutive valid PRACH occasions and R contention based preambles with consecutive indexes associated with the SS/PBCH block per valid PRACH occasion start from preamble index 0. If N≥1, R contention based preambles with consecutive indexes associated with SS/PBCH block n, 0≤n≤N−1, per valid PRACH occasion start from preamble index n·N_{preamble}^{total}/N where N_{preamble}^{total} provided by totalNumberOfRA-Preambles for 4 step RA procedure, and is an integer multiple of N.

SS/PBCH block indexes provided by ssb-PositionsInBurst in SIB1 or in ServingCellConfigCommon are mapped to valid PRACH occasions in the following order:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

To resolve preamble detection issues, in one embodiment of this disclosure, PRACH occasions within an interval of 2*maximum delay difference are assigned different preambles. In one embodiment, the mapping between preambles/SSBs is determined as follows:
RACH configuration signaled by the gNB, R=Number of preambles per SSB; N=Number of SSBs per RO; T=Total number of preambles, K=2*maximum delay difference (in units of PRACH period).
If N<1, R consecutive preambles associated with SSB, starts from preamble index given by i*R.
If N>=1, R consecutive preambles associated with nth SSB of a RO in the ith set of FDMed ROs, starts from preamble index given by [n*(T/N)]+i*R], where 0<=n<=N−1.
0<=i<=m−1; m=number of sets of FDMed ROs in interval K where K=2*the maximum delay difference in units of PRACH periods. Sets of FDMed ROs in interval K are sequentially indexed from 0. Note that interval K can be in units of slots as well.

The first interval K starts from the start of the first PRACH configuration period. In an embodiment, the timer interval K is equal to 2*maximum delay difference in the cell. Maximum delay difference=Maximum propagation delay−minimum propagation delay. The time interval K or maximum delay difference can be signaled by the gNB in system information or dedicated RRC signaling. Alternately, Maximum propagation delay, minimum propagation delay can be signaled by gNB in system information or dedicated RRC signaling. In an embodiment, the timer interval T can be signaled in units of PRACH configuration period. In an embodiment, instead of K, parameter ‘m’ can be signaled, where ‘m’ is the number of sets of FDMed PRACH occasions, 0<=i<m.

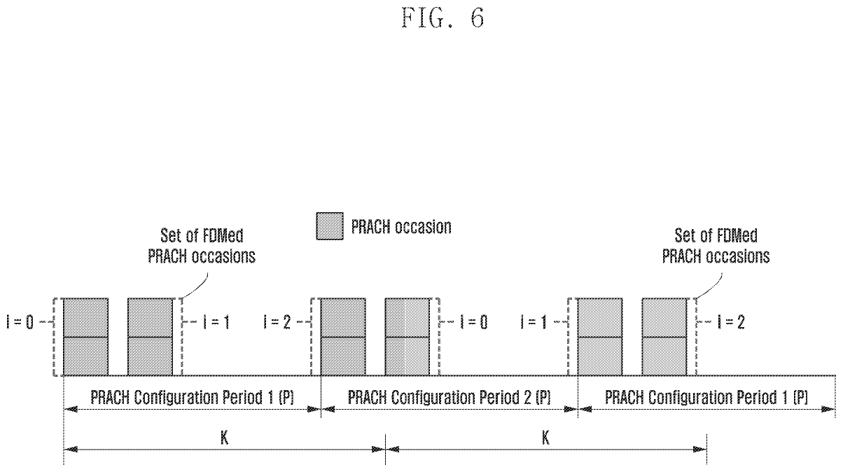

FIG. 6 illustrates another example of PRACH occasions according to an embodiment of the disclosure. In the example, there are three sets of FDMed PRACH occasions in interval K. Each set of FDMed PRACH occasions consists of 2 PRACH occasions. R (#of preambles/SSB)=8; and N (#SSBs/RO)=2. In the example, N>=1. So R consecutive preambles associated with nth SSB of a PRACH occasion in the ith set of FDMed PRACH occasions, starts from preamble index given by [n*(T/N)]+i*R], where 0<=n<=N−1, 0<=i<=m−1; m=number of set of FDMed PRACH occasions in interval K.

For 1st SSB of RO in the ith (i=0) set of FDMed ROs, 8 consecutive preambles are associated starting from preamble index given by [0*(64/2)]+0*8]=0.

For 2nd SSB of RO in the ith (i=0) set of FDMed ROs, 8 preambles are associated and starts from preamble index given by [1*(64/2)]+0*8]=32.

For 1st SSB of RO in the ith (i=1) set of FDMed ROs, 8 preambles are associated and starts from preamble index given by [0*(64/2)]+1*8]=8.

For 2nd SSB of RO in the ith (i=1) set of FDMed ROs, 8 preambles are associated and starts from preamble index given by [1*(64/2)]+1*8]=40.

For 1st SSB of RO in the ith (i=2) set of FDMed ROs, 8 preambles are associated and starts from preamble index given by [0*(64/2)]+2*8]=16.

For 2nd SSB of RO in the ith (i=2) set of FDMed ROs, 8 preambles are associated and starts from preamble index given by [1*(64/2)]+2*8]=48.

The same procedure can also be applied for 2 step RA procedure with separate configuration of PRACH occasions with 4 step RA procedure

For 2 step RA procedure with separate configuration of PRACH occasions with 4 step RA procedure, in one embodiment, the mapping between preambles/SSBs is determined as follows:
RACH configuration signaled by gNB, R1=Number of preambles per SSB; N1=Number of SSBs per RO; T1=Total number of preambles, K1=2*maximum delay difference (in units of PRACH period).
If N<1, R1 consecutive preambles associated with SSB, starts from preamble index given by m*R+i*R1, m=number of sets of FDMed ROs in interval K for 4 step RA procedure. R=Number of preambles per SSB for 4 step RA procedure.
If N>=1, R1 consecutive preambles associated with nth SSB of a RO in the ith set of FDMed ROs, starts from preamble index given by [n*(T/N1)]+i*R1+m*R], where 0<=n<=N1−1.
0<=i<=m1−1; m1=number of sets of FDMed ROs in interval K where K=2*the maximum delay difference in units of PRACH periods. Sets of FDMed ROs in interval K1 are sequentially indexed from 0. Note that interval K1 can be in units of slots as well.

In an embodiment, instead of K, parameter ‘m1’ can be signaled, where ‘m1’ is the number of sets of FDMed PRACH occasions, 0<=i<ml.

The first interval K1 starts from the start of first PRACH configuration period. In an embodiment, the timer interval K1 is equal to 2*maximum delay difference in cell. Maximum delay difference=Maximum propagation delay−minimum propagation delay. The time interval K or maximum delay difference can be signaled by gNB in system information or dedicated RRC signaling. Alternately, Maximum propagation delay, minimum propagation delay can be signaled by gNB in system information or dedicated RRC signaling. In an embodiment, the timer interval T can be signaled in units of PRACH configuration period.

### Embodiment 2—4 Step RA Based Small Data Transmission (SDT) Solution for NR

2.1 Overall Procedure.

The objective is to enable small data transmission in RRC_INACTIVE state. The uplink data is transmitted in Msg3 when 4 step RA procedure is used for small data transmission. It is not sufficient to transmit only uplink data in Msg3. Along with the uplink data, additional information (such as those listed below) also need to be transmitted:
Resume Identity (short or full I-RNTI) to identify the UE's context and last serving gNB (if the gNB to which UE is transmitting UL data is different from the gNB where UE has last received RRCRelease with suspend configuration). The gNB can indicate (e.g., in system information or an RRC message) whether UE should transmit short or full I-RNTI as a resume identity.
Authentication token (i.e. resumeMAC-I) to authenticate UE.

To carry the above information, RRCResumeRequest/RRCResumeRequest1 message can be transmitted along with uplink data, wherein the RRCResumeRequest is transmitted if the Short I-RNTI is to be transmitted to the gNB, the RRCResumeRequest1 is transmitted if the full I-RNTI is to be transmitted to the gNB. RRCResumeRequest/RRCResumeRequest1 are transmitted on signaling radio bearer 0 (SRB0) and hence they are not protected. The resumeMAC-I is generated using the RRC integrity key from the previous RRC connection. The RRC integrity key from the previous RRC connection is available from a stored AS context, wherein the UE stores the AS context when it enters RRC_INACTIVE upon receiving RRCRelease message with suspendConfig.

Upon receiving the uplink data together with RRCResumeRequest/RRCResumeRequest1 message, the gNB can send RRCRelease indicating the completion of small data transmission and the UE remains in RRC_INACTIVE. If the gNB has DL data, it can be sent together with RRCRelease. If the gNB has more DL data or is aware of more UL data in UE, the gNB can send RRCResume instead of RRCRelease. RRCRelease and RRCResume are transmitted on SRB1. They are both ciphered and integrity protected using the security keys (e.g., K_{RRCenc} for ciphering and K_{RRCint} for integrity protection) delivered according to nexthop chaining count (NCC) received in the RRCRelease message of the previous RRC connection. The user data in uplink and downlink are ciphered and integrity protected (only for data radio bearers (DRBs) which are configured with integrity protection enabled) using the security keys (e.g., K_{UPenc} for ciphering and K_{UPint} for integrity protection) derived according to NCC received in the RRCRelease message of the previous RRC connection.

2.1.1 Signaling Flow without Context Fetch.

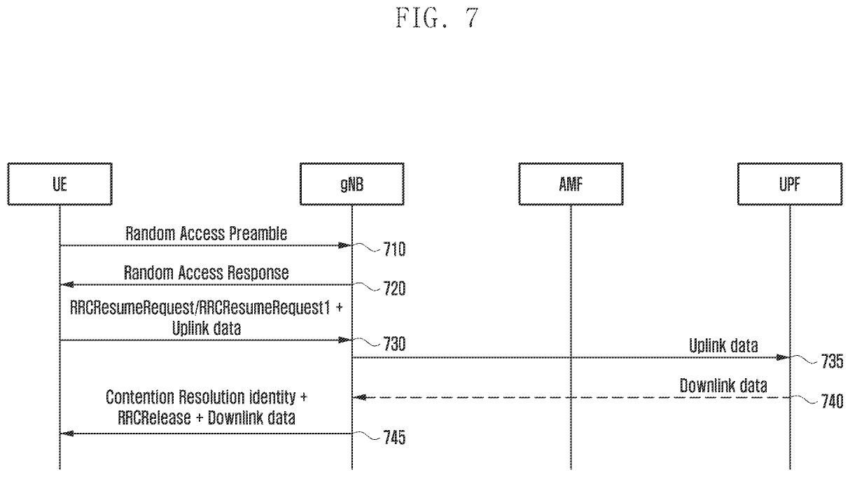

FIG. 7 illustrates an example of signaling flow for small data transmission according to an embodiment of the disclosure.

Referring to FIG. 7, it shows the signaling flow for small data transmission using 4 step RA. In this embodiment, it is assumed that the gNB has the UE's context.

The UE is in RRC_INACTIVE state. Criteria to initiate 4 step RA for SDT are met (When the UE is in RRC_INACTIVE state and neither an SDT procedure nor a connection resume procedure is ongoing, the SDT procedure can be initiated if data becomes available only for RB(s) for which SDT is allowed. If data becomes available for RB(s) for which SDT is not allowed, the UE initiates the RRC connection resume procedure wherein the data is transmitted/received from the gNB after entering the RRC_CONNECTED, data is not transmitted/received during the connection resume procedure and common RA resources are used for RA initiated for the RRC connection resume procedure. The gNB indicates (e.g., in an RRCRelease message or an RRCReconfiguration message) for which RB(s) SDT is allowed. See section 2.1.5 below for further details). The UE selects an SSB and then a preamble/RO for the selected SSB from preambles/ROs for SDT (see section 2.1.3 and 2.1.4 below for details). The UE transmits the RA preamble at operation 710 and receives RAR at operation 720 including a UL grant for Msg3 transmission. For RAR, the UE monitors the PDCCH addressed to the RA-RNTI in the RAR search space. The RA-RNTI is calculated as follows: RA-RNTI=1+s_id+14*t_id+14*80*f_id+14*80*8*ul_carrier_id, where s_id is the index of the first OFDM symbol of the PRACH occasion where UE has transmitted Msg1, i.e., the RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Note that the UE will select the UL carrier (SUL or NUL) when the RA procedure is initiated.

The UE sends an RRCResumeRequest/RRCResumeRequest1 to the gNB (same as the last serving gNB) on SRB 0 at operation 730. It includes a full/short I-RNTI (e.g., resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (integrity algorithm for NR (NIA) or EPS integrity algorithm (EIA)) in the stored access stratum (AS) security context, which was negotiated between the UE and the last serving gNB and the K_{RRCint} from the stored AS security context with the following inputs:
KEY: shall be set to current K_{RRCint};
BEARER: all bits shall be set to 1;
DIRECTION: bit shall be set to 1;
COUNT: all bits shall be set to 1;
MESSAGE: shall be set to VarResumeMAC-Input with following inputs:
   source PCI (set to the physical cell identity of the PCell the UE was connected to prior to suspension of the RRC connection);
   target Cell-ID (set to the cell Identity of the first PLMN-Identity included in the PLMN-IdentityInfoList broadcast in SIB1 of the target cell, i.e., the cell to which the UE is sending small data);
   source C-RNTI (set to the C-RNTI that the UE had in the PCell it was connected to prior to suspension of the RRC connection).

The UE resumes SRBs and DRBs, derives new security keys (K_{RRCenc} key, the K_{RRCint} key, K_{UPint} key and the K_{UPenc} key) using the NCC provided in the RRCRelease message of the previous RRC connection and re-establishes the AS security. The user data are ciphered and integrity protected (only for DRBs configured with user plane (UP) integrity protection) using the security keys (K_{UPint} key for integrity protection and the K_{UPenc} key for ciphering) and transmitted on a DTCH multiplexed with the RRCResumeRequest/RRCResumeRequest1 message on the CCCH.

The gNB validates the resumeMAC-I. If the verification of the ResumeMAC-I is successful, then the gNB calculates K_{NG-RAN}* using the target cell physical cell identifier (PCI), target absolute radio frequency channel number (ARFCN)-DL and the K_{gNB}/NH in the current UE 5G AS security context based on either a horizontal key derivation or a vertical key derivation according to the NCC which was sent to UE in the release message of the previous RRC connection. The gNB can obtain the target PCI and target ARFCN-DL from a cell configuration database by means of the target Cell-ID which was received from the UE in the resume message. The gNB derives new security keys (K_{RRCenc} key, the K_{RRCint} key, K_{UPint} key and the K_{UPenc} key). The gNB decrypts the uplink data and verifies MAC I (if uplink data is integrity protected) and delivers the uplink data to a UP function (UPF) at operation 735. Note that this procedure is the same as in the case of context fetch except that the source gNB and the target gNB are same in this case.

The gNB sends the RRCRelease message to keep the UE in RRC_INACTIVE. The PDCCH is addressed to TC-RNTI. If downlink data is available at operation 740, they are sent ciphered and integrity protected (only for DRBs configured with UP integrity protection) using the security keys (K_{UPint} key for integrity protection and the K_{UPenc} key for ciphering) on a DTCH multiplexed with the RRCRelease message on DCCH at operation 745.

In an alternate embodiment, RRCRelease is not sent along with Contention resolution identity and is send later. In between transmission of contention resolution identity and transmission of RRCRelease message, the gNB can schedule a UL grant (a PDCCH addressed to C-RNTI, i.e., a TC-RNTI received in RAR which is promoted to C-RNTI upon contention resolution is successful). Note that the UE continues to remain in RRC_INACTIVE state after contention resolution is successful. The user data transmitted/received in between reception of contention resolution identity and reception of RRCRelease message are ciphered and integrity protected (only for DRBs configured with UP integrity protection) using the security keys (K_{UPint} key for integrity protection and the K_{UPenc} key for ciphering) In the UL transmission the UE can indicate if it has more data to transmit. If the UE has more data to transmit, the gNB can schedule a UL grant, otherwise RRCRelease. In the UL transmission, the UE can also include SSB ID(s) of an SSB above threshold if the SSB indicated by the PRACH preamble is no longer suitable.

2.1.2 Signaling Flow with Context Fetch and Path Switching.

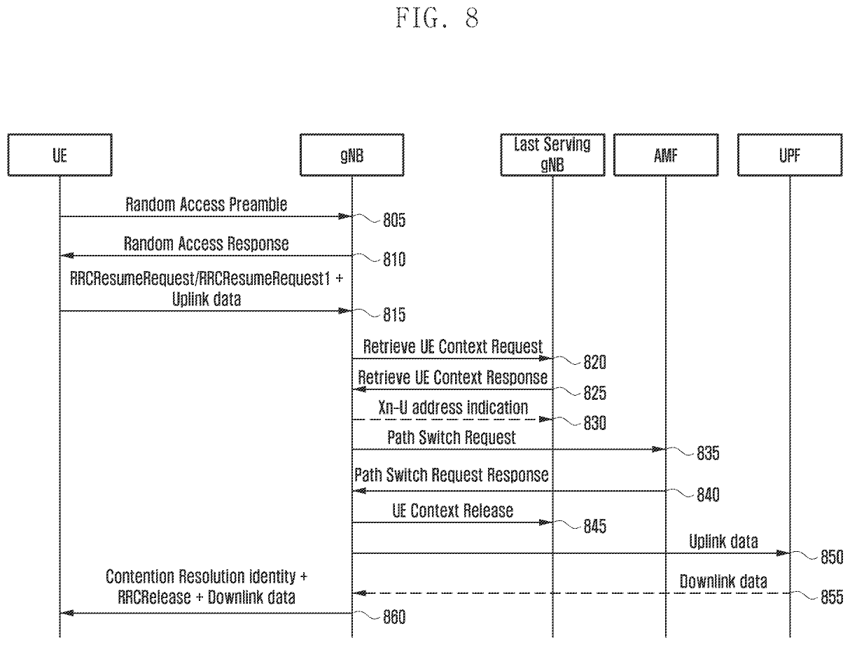

FIG. 8 illustrates another example of signaling flow for small data transmission according to an embodiment of the disclosure.

Referring to FIG. 8, it shows the signaling flow for small data transmission using 4 step RA. In this case it is assumed the gNB does not have the UE's context and fetches the context from the last serving gNB. Path switch is performed and context is released from last serving gNB.

The UE is in RRC_INACTIVE state. Criteria to initiate 4 step RA for SDT is met (when the UE is in RRC_INACTIVE state and neither the SDT procedure nor a connection resume procedure is ongoing, the SDT procedure is initiated if data becomes available only for RB(s) for which SDT is allowed. If data becomes available for RB(s) for which SDT is not allowed, the UE initiates a connection resume procedure wherein the data is transmitted/received from the gNB after entering RRC_CONNECTED, data is not transmitted/received during the connection resume procedure and common RA resources are used for RA initiated for an RRC connection resume procedure. The gNB indicates (e.g., in an RRCRelease message or RRCReconfiguration message) for which RB(s) SDT is allowed. See section 2.1.5 below for further details). The UE select the SSB and then the preamble/RO for the selected SSB from preambles/ROs for SDT (see section 2.1.3 and 2.1.4 below for details). The UE transmits the RA preamble and receives RAR including a UL grant for Msg3 transmission at operations 805 and 810. For RAR, the UE monitors the PDCCH addressed to the RA-RNTI in the RAR search space. The RA-RNTI is calculated as follows: RA-RNTI=1+s_id+14*t_id+14*80*f_id+14*80*8*ul_carrier_id, where s_id is the index of the first OFDM symbol of the PRACH occasion where the UE has transmitted Msg1, i.e., the RA preamble; 0≤s_id<14; t_id is the index of the first slot of the PRACH occasion (0≤t_id<80); fid is the index of the PRACH occasion within the slot in the frequency domain (0≤f_id<8), and ul_carrier_id is the UL carrier used for Msg1 transmission (0 for NUL carrier and 1 for SUL carrier. Note that the UE will select the UL carrier (SUL or NUL) when the RA procedure is initiated.

The UE sends an RRCResumeRequest/RRCResumeRequest1 to the gNB (different from the last serving gNB) on SRB 0 at operation 815. It includes a full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA or EIA) in the stored AS security context, which was negotiated between the UE and the last serving gNB and the K_{RRCint} from the stored AS security context with the following inputs:
KEY: shall be set to current K_{RRCint};
BEARER: all bits shall be set to 1;
   DIRECTION: bit shall be set to 1;
COUNT: all bits shall be set to 1;
MESSAGE: shall be set to VarResumeMAC-Input with following inputs:
   source PCI (set to the physical cell identity of the PCell the UE was connected to prior to suspension of the RRC connection);
   target Cell-ID (set to the cellIdentity of the first PLMN-Identity included in the PLMN-IdentityInfoList broadcast in SIB1 of the target cell, i.e., the cell the UE is trying to resume)
   source C-RNTI (set to C-RNTI that the UE had in the PCell it was connected to prior to suspension of the RRC connection).

The UE resumes SRBs and DRBs, derives new security keys using the NCC provided in the RRCConnectionRelease message of the previous RRC connection and re-establishes the AS security. The user data are ciphered and integrity protected (only for DRBs configured with UP integrity protection) using the security keys (K_{UPint} key for integrity protection and the K_{UPenc} key for ciphering) and transmitted on a DTCH multiplexed with the RRCResumeRequest/RRCResumeRequest1 message on the CCCH.

The gNB (i.e., a target gNB) identifies the gNB identity of a last serving gNB (i.e., a source gNB) from the I-RNTI and requests it to provide the UE's context data by sending a Retrieve UE Context Request message at operation 820 with the following included: the I-RNTI, the ResumeMAC-I, and target Cell-ID, in order to allow the source gNB to validate the UE request and to retrieve the UE context.

The last serving gNB (i.e., the source gNB) validates the resumeMAC-I and provides the UE context data.

The source gNB retrieves the stored UE context including the UE 5G AS security context from its database using the I-RNTI. The source gNB verifies the ResumeMAC-I using the current K_{RRCint} key stored in the retrieved UE 5G AS security context (calculating the ResumeMAC-I as described above). If the verification of the ResumeMAC-I is successful, then the source gNB calculates K_{NG-RAN}* using the target cell PCI, target ARFCN-DL and the K_{gNB}/NH in the current UE 5G AS security context based on either a horizontal key derivation or a vertical key derivation according to whether the source gNB has an unused pair of {NCC, NH}. The source gNB can obtain the target PCI and target ARFCN-DL from a cell configuration database by means of the target Cell-ID which was received from the target gNB. Then the source gNB shall respond with an Xn-AP Retrieve UE Context Response message to the target gNB including the UE context that contains the UE 5G AS security context at operation 825. The UE 5G AS security context sent to the target gNB shall include the newly derived K_{NG-RAN}*, the NCC associated to the K_{NG-RAN}*, the UE 5G security capabilities, UP security policy, the UP security activation status with the corresponding PDU session ID(s), and the ciphering and integrity algorithms used by the UE with the source cell.

If loss of DL user data buffered in the last serving gNB shall be prevented, the gNB provides forwarding addresses at operation 830.

The gNB performs a path switch at operations 835 and 840.

The gNB triggers the release of the UE resources at the last serving gNB at operation 845.

The gNB delivers the uplink data to UPF at operation 850.

The gNB sends the RRCRelease message to keep the UE in RRC_INACTIVE. The PDCCH is addressed to the TC-RNTI. If downlink data is available, it is sent ciphered and integrity protected (only for DRBs configured with UP integrity protection) using the security keys (K_{UPint} key for integrity protection and the K_{UPenc} key for ciphering) on a DTCH multiplexed with the RRCRelease message on the DCCH at operations 855 and 860.

In an alternate embodiment, RRCRelease is not sent along with Contention resolution identity, but is sent later. In between transmission of contention resolution identity and transmission of RRCRelease, the gNB can schedule a UL grant (a PDCCH addressed to the C-RNTI, i.e., the TC-RNTI received in RAR which is promoted to C-RNTI upon successful contention resolution). Note that the UE continues to remain in RRC_INACTIVE state after the contention resolution is successful. The user data transmitted/received in between reception of contention resolution identity and reception of RRCRelease message is ciphered and integrity protected (only for DRBs configured with UP integrity protection) using the security keys (K_{UPint} key for integrity protection and the K_{UPenc} key for ciphering). In the UL transmission, the UE can indicate if it has more data to transmit. If the UE has more data to transmit, the gNB can schedule a UL grant, otherwise RRCRelease. In the UL transmission, the UE can also include SSB ID(s) of SSB above threshold if the SSB indicated by the PRACH preamble is no longer suitable.

2.1.3 ROs for SDT Using 4 Step RA.

4 step ROs for SDT can be shared with 4 step ROs for non SDT or can be separately configured. The following parameters are signaled by the gNB for configuring ROs for small data transmission using 4 step RA.
prach-ConfigurationIndex-SDT.
A PRACH configuration index for SDT using 4 step RA. The gNB has the option to not signal prach-ConfigurationIndex-SDT. If prach-ConfigurationIndex-SDT is not signaled by the gNB, the UE determines PRACH occasions for SDT according to prach-ConfigurationIndex configured/signaled by the gNB for non SDT (i.e., in an RACH-ConfigGeneric for 4 step RA). This field may only be present in the case of separate ROs for 4 step RA based SDT.
msg1-FDM-SDT.
   The number of msg1 PRACH transmission occasions FDMed in one time instance for small data transmission. If the field is absent, the UE shall use the value of msg1-FDM in RACH-ConfigGeneric. This field may only be present in the case of separate ROs for small data transmission.
msg1-FrequencyStart-SDT.
   Offset of lowest PRACH transmissions occasion in the frequency domain with respect to PRB 0. If the field is absent, the UE shall use the value of msg1-FrequencyStart in RACH-ConfigGeneric. This field may only be present in the case of separate ROs for 4 step RA based SDT.

For flexible signaling of ROs for SDT, the following parameters of Table 1 can be configured in RACH configuration for 4 step RA based SDT.

TABLE 1
prach-ConfigurationPeriodScaling-SDT
Scaling factor to extend the periodicity of the baseline configuration
indicated byp rach-ConfigurationIndex-SDT. Value scf1 corresponds
to scaling factor of 1 and so on.
prach-ConfigurationFrameOffset-SDT
Scaling factor for ROs defined in the baseline configuration indicated
by prach-ConfigurationIndex-SDT.
prach-ConfigurationS Offset-SDT
Subframe/Slot offset for ROs defined in the baseline configuration
indicated by prach-ConfigurationIndex-SDT.

2.1.4 RA Preambles for SDT Using 4 Step RA.

The following options are supported for determining preambles for SDT
Option 1: ROs used for SDT are same as ROs for non SDT.
   Case 1: 2 step RA is not configured, or 2 step RA is configured but ROs for 2 step RA are not shared with 4 step RA.
      ssb-perRACH-Occasion (N1) is configured for 4 step RA.
      CB-PreamblesPerSSB (R1) is configured for 4 step RA.
      CB-PreamblesPerSSB-SDT (X) is configured for SDT using 4 step RA.
      if N1≤1, one SS/PBCH block is mapped to 1/N1 consecutive valid PRACH occasions and X contention based preambles with consecutive indexes associated with the SS/PBCH block per valid PRACH occasion start from preamble index R1. If N1≥1, X contention based preambles with consecutive indexes associated with SS/PBCH block n, 0≤n≤N1−1, per valid PRACH occasion start from preamble index n·N_{preamble}^{total}/N1+R1, where N_{preamble}^{total} is provided by totalNumberOfRA-Preambles for 4 step RA procedure.
   Case 2: 2 step RA is configured and ROs for 2 step RA are shared with 4 step RA.
      ssb-perRACH-Occasion (N1) is configured for 4 step RA.
      CB-PreamblesPerSSB (R1) is configured for 4 step RA.
      CB-PreamblesPerSSB (R2) is configured for 2 step RA.
      CB-PreamblesPerSSB-SDT (X) is configured for SDT using 4 step RA.
      if N1<1, one SS/PBCH block is mapped to 1/N1 consecutive valid PRACH occasions and X contention based preambles with consecutive indexes associated with the SS/PBCH block per valid PRACH occasion start from preamble index R1+R2. If N1≥1, X contention based preambles with consecutive indexes associated with SS/PBCH block n, 0≤n≤N1−1, per valid PRACH occasion start from preamble index n·N_{preamble}^{total}/N1+R1+R2, where N_{preamble}^{total} is provided by totalNumberOfRA-Preambles for 4 step RA procedure
   Alternate option to cover both case 1 and case 2
      CB-PreamblesPerSSB-SDT (X) is configured for SDT using 4 step RA.
      ssb-perRACH-Occasion (N1) configured for 4 step RA.
      Starting preamble index (S) for SDT using 4 step RA is configured.
      if N1<1, one SS/PBCH block is mapped to 1/N1 consecutive valid PRACH occasions and X contention based preambles with consecutive indexes associated with the SS/PBCH block per valid PRACH occasion start from preamble index S. If N1≥1, X contention based preambles with consecutive indexes associated with SS/PBCH block n, 0≤n≤N1−1, per valid PRACH occasion start from preamble index n·_{preamble}^{total}/N1+S, where N_{preamble}^{total} is provided by totalNumberOfRA-Preambles for 4 step RA procedure.
Option 2: ROs used for SDT are different from ROs for non SDT.
   CB-PreamblesPerSSB-SDT (X) is configured for SDT using 4 step RA.
   ssb-perRACH-Occasion-SDT (Y) is configured for SDT using 4 step RA.
      if Y<1, one SS/PBCH block is mapped to 1/Y consecutive valid PRACH occasions and X contention based preambles with consecutive indexes associated with the SS/PBCH block per valid PRACH occasion start from preamble index 0. If Y≥1, X contention based preambles with consecutive indexes associated with SS/PBCH block n, 0≤n≤Y−1, per valid PRACH occasion start from preamble index n·N_{preamble}^{total}/Y, where N_{preamble}^{total} is provided by totalNumberOfRA-Preambles for SDT 4 step RA procedure. If totalNumberOfRA-Preambles for SDT 4 step RA procedure is not configured, UE assumes the value is 64.
Simple option to cover both shared (option 1) and non shared (option 2).
   Starting preamble index (S) for SDT using 4 step RA is configured.
   CB-PreamblesPerSSB-SDT (X) is configured for SDT using 4 step RA.
   ssb-perRACH-Occasion-SDT (Y) is configured for SDT using 4 step RA.
   if Y<1, one SS/PBCH block is mapped to 1/Y consecutive valid PRACH occasions and X contention based preambles with consecutive indexes associated with the SS/PBCH block per valid PRACH occasion start from preamble index S. If Y≥1, X contention based preambles with consecutive indexes associated with SS/PBCH block n, 0≤n≤Y−1, per valid PRACH occasion start from preamble index n·N_{preamble}^{total}/Y+S, where N_{preamble}^{total} is provided by totalNumberOfRA-Preambles for SDT 4 step RA procedure. If totalNumberOfRA-Preambles for SDT 4 step RA procedure is not configured, the UE assumes the value is 64.

The RACH parameters for small data transmission are configured for initial UL BWP (separately for NUL and SUL). If any other UL BWP is used for SDT, RACH parameters for small data transmission can also be configured for those UL BWPs as well. If multiple preamble groups are supported for small data transmission, information to determine number of preambles per group is also configured in the RACH parameters for small data transmission. Other parameters (such as RAR window, power ramping step, received target power etc.) can also be configured in the RACH parameters for small data transmission and if not configured, the UE applies the corresponding parameters from RACH-ConfigGeneric for 4 step RA. Separate BWP for SDT can be configured. As initial BWP could be narrow while SDT may require wider BW. Alternately, a UL grant in RAR can indicate RBs outside initial BWP.

2.1.5 Criteria to Determine Whether to Use 4 Step RA for SDT or not.

The UE selects the UL carrier, UL BWP, and RA Type as described earlier. It is assumed that 4 step RA is selected. The UE can perform SDT using 4 step RA if the following condition(s) are met. Otherwise, the UE performs connection resume procedure without SDT. Note that in an embodiment the UE may apply a subset of conditions below to determine whether to perform SDT.

Condition 1: the upper layers request resumption of an RRC connection and the resumption request is for mobile originating calls and the establishment cause is mo-Data.

Condition 2: the UE supports SDT.

Condition 3: system information includes SDT configuration for 4 step RA.

Condition 4: the UE has a stored value of the NCC provided in the RRCRelease message with suspend indication during the preceding suspend procedure. In an embodiment, where the NCC is always provided in the RRCRelease message with suspend indication and the UE always stores it, this condition is not required to be checked.

Condition 5: RRCRelease message with suspend indication during the preceding suspend procedure indicates that UE is allowed to perform SDT using 4 step RA.

NOTE: In order to control the UEs which can perform SDT, the network can indicate whether the UE is allowed to perform SDT or not in RRCRelease. If not allowed, the UE will perform connection resume. Indication can be common for all methods of SDT. Indication can be separate for 4 step RA and 2 step RA.

Condition 6: If the logical channel (LCH) restrictions for logical channel prioritization (LCP) are applied for SDT and all LCHs for which data is available for transmission are allowed to be multiplexed in Msg3 according to LCH restrictions.

Note: the Network (i.e., the gNB) can also indicate the radio bearers (RBs) for which SDT is allowed. The gNB can inform this using RRCRelease message or RRCReconfiguration message while the UE is in RRC_CONNECTED. In this case in Condition 6, LCHs corresponding to the RBs for which SDT is allowed are considered. While the UE is in RRC_INACTIVE, if data is available for transmission for RBs other than RBs for which SDT is allowed, the UE shall initiate connection resume without SDT.

Condition 7: Msg3 transport block size (TBS) and signal quality threshold criteria as explained below are met. One of the following options can be used to configure Msg3 TBS for SDT and to determine whether to use 4 step RA for small data transmission or normal connection resume.

Option 1: Single TBS, No Signal Quality Based Threshold.

The gNB configures the parameter sdt-TBS which indicates the maximum allowed transport block size for small data transmission using 4 step RA. The gNB selects a value for sdt-TBS from a set of configurable values. The parameter is separately configured for SUL and NUL as UL coverage is different for SUL and NUL.
If the message size (UL data available for transmission plus MAC header and, where required, MAC control elements) is less than or equal to the TB size signaled in sdt-TBS for the UL carrier selected for the RA procedure:
   The UE initiates 4 step RA for small data transmission. Preamble group selection is not performed during this RA procedure.
Else
   The UE initiates 4 step RA for resuming connection (small data is not included).

Option 2: Single TBS, Single RSRP Threshold.

The gNB configures the parameter sdt-TBS which indicates the maximum allowed transport block size for small data transmission using 4 step RA. The gNB also configures the parameter sdt-Threshold. These parameters are separately configured for SUL and NUL as UL coverage is different for SUL and NUL.
If the message size (UL data available for transmission plus MAC header and, where required, MAC control elements) is less than or equal to the TB size signaled in sdt-TBS for the UL carrier selected for RA procedure and RSRP of the downlink pathloss reference is greater than or equal to sdt-Threshold:
   The UE initiates 4 step RA for small data transmission. Preamble group selection is not performed during this RA procedure.
Else
   The UE initiates 4 step RA for resuming connection (small data is not included).

Option 3: Multiple [TBS Size, Threshold, Preamble Group].

The gNB configures the parameters sdt-TBS-groupA and sdt-TBS-groupB which indicate the maximum allowed transport block sizes for small data transmission using 4 step RA for preamble group A and preamble group B, respectively. sdt-Threshold-groupB is also configured. These parameters are separately configured for SUL and NUL as UL coverage is different for SUL and NUL.
If the message size (UL data available for transmission plus MAC header and, where required, MAC control elements) is less than equal to the TB size signaled in sdt-TBS-groupA:
   The UE performs small data transmission using 4 step RA. Group A is selected.
Else if the message size (UL data available for transmission plus MAC header and, where required, MAC control elements) is greater than TB size signaled in sdt-TBS-groupA and is less than or equal to the TB size signaled in sdt-TBS-groupB for the selected UL carrier and RSRP of the downlink pathloss reference is greater than or equal to sdt-Threshold-groupB:
   The UE performs small data transmission using 4 step RA. Group B is selected.
Else
The UE initiates 4 step RA for resuming connection (small data is not included).

This option can be generalized wherein gNB configures the parameters sdt-TBS-group1 and sdt-TBS-groupN; sdt-Threshold-group2 to sdt-Threshold-groupN, preambles for groups 1 to N.
If the message size (UL data available for transmission plus MAC header and, where required, MAC control elements) is less than or equal to the TB size signaled in sdt-TBS-group1:
   The UE performs small data transmission using 4 step RA. Group 1 is selected.
Else if the message size (UL data available for transmission plus MAC header and, where required, MAC control elements) is greater than TB size signaled in sdt-TBS-group1 and is less than equal to the TB size signaled in sdt-TBS-group2 for the selected UL carrier and RSRP of the downlink pathloss reference is greater than or equal to sdt-Threshold-group2:
   The UE performs small data transmission using 4 step RA. Group 2 is selected.
Else if the message size (UL data available for transmission plus MAC header and, where required, MAC control elements) is greater than TB size signaled in sdt-TBS-group2 and is less than or equal to the TB size signaled in sdt-TBS-group3 for the selected UL carrier and RSRP of the downlink pathloss reference is greater than or equal to sdt-Threshold-group3:
   The UE performs small data transmission using 4 step RA. Group 3 is selected.
Else if the message size (UL data available for transmission plus MAC header and, where required, MAC control elements) is greater than TB size signaled in sdt-TBS-groupN−1 and is less than or equal to the TB size signaled in sdt-TBS-groupN for the selected UL carrier and RSRP of the downlink pathloss reference is greater than or equal to sdt-Threshold-groupN:
   The UE performs small data transmission using 4 step RA. Group N is selected.
Else:
   The UE initiates 4 step RA for resuming connection (small data is not included).

Option 3A:

The gNB configures the parameters sdt-TBS-groupA and sdt-TBS-groupB which indicate the maximum allowed transport block sizes for small data transmission using 4 step RA for preamble group A and preamble group B, respectively. sdt-Threshold-groupA and sdt-Threshold-groupB are also configured. These parameters are separately configured for SUL and NUL as UL coverage is different for SUL and NUL.
If the message size (UL data available for transmission plus MAC header and, where required, MAC control elements) is less than or equal to the TB size signaled in sdt-TBS-groupA and RSRP of the downlink pathloss reference is greater than or equal to sdt-Threshold-groupA:
   The UE performs small data transmission using 4 step RA. Group A is selected.
Else if the message size (UL data available for transmission plus MAC header and, where required, MAC control elements) is greater than TB size signaled in sdt-TBS-groupA and is less than or equal to the TB size signaled in sdt-TBS-groupB for the selected UL carrier and RSRP of the downlink pathloss reference is greater than or equal to sdt-Threshold-groupB:
   The UE performs small data transmission using 4 step RA. Group B is selected.
Else
   The UE initiates 4 step RA for resuming connection (small data is not included).

This option can be generalized wherein the gNB configures the parameters sdt-TBS-group1 and sdt-TBS-groupN; sdt-Threshold-group1 to sdt-Threshold-groupN, preambles for groups 1 to N.
If the message size (UL data available for transmission plus MAC header and, where required, MAC control elements) is less than or equal to the TB size signaled in sdt-TBS-group1 and RSRP of the downlink pathloss reference is greater than or equal to sdt-Threshold-group1:
   The UE performs small data transmission using 4 step RA. Group 1 is selected.
Else if the message size (UL data available for transmission plus MAC header and, where required, MAC control elements) is greater than TB size signaled in sdt-TBS-group1 and is less than or equal to the TB size signaled in sdt-TBS-group2 for the selected UL carrier and RSRP of the downlink pathloss reference is greater than or equal to sdt-Threshold-group2:
   The UE performs small data transmission using 4 step RA. Group 2 is selected.
Else if the message size (UL data available for transmission plus MAC header and, where required, MAC control elements) is greater than TB size signaled in sdt-TBS-group2 and is less than or equal to the TB size signaled in sdt-TBS-group3 for the selected UL carrier and RSRP of the downlink pathloss reference is greater than or equal to sdt-Threshold-group3:
   The UE performs small data transmission using 4 step RA. Group 3 is selected.
Else if the message size (UL data available for transmission plus MAC header and, where required, MAC control elements) is greater than TB size signaled in sdt-TBS-groupN−1 and is less than or equal to the TB size signaled in sdt-TBS-groupN for the selected UL carrier and RSRP of the downlink pathloss reference is greater than or equal to sdt-Threshold-groupN:
   The UE performs small data transmission using 4 step RA. Group N is selected.
Else:
   The UE initiates 4 step RA for resuming connection (small data is not included).

Option 4: Single TBS, Single messagePowerOffsetSDT for Pathloss Threshold.

The gNB configures the parameter sdt-TBS which indicates the maximum allowed transport block size for small data transmission using 4 step RA. The gNB also configures the parameter messagePowerOffsetSDT. These parameters are separately configured for SUL and NUL as UL coverage is different for SUL and NUL.
If the message size (UL data available for transmission plus MAC header and, where required, MAC control elements) is less than or equal to the TB size signaled in sdt-TBS for the UL carrier selected for RA procedure and the pathloss is less than PCMAX (of the Serving Cell performing the RA Procedure)−preambleReceivedTargetPower−msg3-DeltaPreamble−messagePowerOffsetSDT:
   The UE initiates 4 step RA for small data transmission.
Else
   The UE initiates 4 step RA for resuming connection (small data is not included).

Option 5: Multiple [TBS Size, messagePowerOffsetSDT, Preamble Group].

The gNB configures the parameters sdt-TBS-groupA and sdt-TBS-groupB which indicate the maximum allowed transport block sizes for small data transmission using 4 step RA for preamble group A and preamble group B, respectively. These parameters are separately configured for SUL and NUL as UL coverage is different for SUL and NUL.
If the message size (UL data available for transmission plus MAC header and, where required, MAC control elements) is less than or equal to the TB size signaled in sdt-TBS-groupA:
   The UE performs small data transmission using 4 step RA. Group A is selected.
Else if the message size (UL data available for transmission plus MAC header and, where required, MAC control elements) is greater than TB size signaled in sdt-TBS-groupA and is less than or equal to the TB size signaled in sdt-TBS-groupB for the selected UL carrier and the pathloss is less than PCMAX (of the Serving Cell performing the RA Procedure)−preambleReceivedTargetPower−msg3-DeltaPreamble−messagePowerOffsetGroupB:
   The UE performs small data transmission using 4 step RA. Group B is selected.
Else
   The UE initiates 4 step RA for resuming connection (small data is not included).

This option can be generalized wherein the gNB configures the parameters sdt-TBS-group1 and sdt-TBS-groupN; messagePowerOffsetGroup2 to messagePowerOffsetGroupN, preambles for groups 1 to N.
If the message size (UL data available for transmission plus MAC header and, where required, MAC control elements) is less than or equal to the TB size signaled in sdt-TBS-group1:
   The UE performs small data transmission using 4 step RA. Group 1 is selected.
Else if the message size (UL data available for transmission plus MAC header and, where required, MAC control elements) is greater than TB size signaled in sdt-TBS-group1 and is less than or equal to the TB size signaled in sdt-TBS-group2 for the selected UL carrier and the pathloss is less than PCMAX (of the Serving Cell performing the RA Procedure)−preambleReceivedTargetPower−msg3-DeltaPreamble−messagePowerOffsetGroup2:
   The UE performs small data transmission using 4 step RA. Group 2 is selected.
Else if the message size (UL data available for transmission plus MAC header and, where required, MAC control elements) is greater than TB size signaled in sdt-TBS-group2 and is less than or equal to the TB size signaled in sdt-TBS-group3 for the selected UL carrier and the pathloss is less than PCMAX (of the Serving Cell performing the RA Procedure)−preambleReceivedTargetPower−msg3-DeltaPreamble−messagePowerOffsetGroup3:
   The UE performs small data transmission using 4 step RA. Group 3 is selected.
Else if the message size (UL data available for transmission plus MAC header and, where required, MAC control elements) is greater than TB size signaled in sdt-TBS-groupN−1 and is less than or equal to the TB size signaled in sdt-TBS-groupN for the selected UL carrier and the pathloss is less than PCMAX (of the Serving Cell performing the RA Procedure)−preambleReceivedTargetPower−msg3-DeltaPreamble−messagePowerOffsetGroupN:
   The UE performs small data transmission using 4 step RA. Group N is selected.
Else:
   The UE initiates 4 step RA for resuming connection (small data is not included).

Option 5A:

The gNB configures the parameters sdt-TBS-groupA and sdt-TBS-groupB which indicate the maximum allowed transport block sizes for small data transmission using 4 step RA for preamble group A and preamble group B, respectively. These parameters are separately configured for SUL and NUL as UL coverage is different for SUL and NUL.
If the message size (UL data available for transmission plus MAC header and, where required, MAC control elements) is less than or equal to the TB size signaled in sdt-TBS-groupA and the pathloss is less than PCMAX (of the Serving Cell performing the RA Procedure)−preambleReceivedTargetPower−msg3-DeltaPreamble−messagePowerOffsetGroupA:
   The UE performs small data transmission using 4 step RA. Group A is selected.
Else if the message size (UL data available for transmission plus MAC header and, where required, MAC control elements) is greater than TB size signaled in sdt-TBS-groupA and is less than or equal to the TB size signaled in sdt-TBS-groupB for the selected UL carrier and the pathloss is less than PCMAX (of the Serving Cell performing the RA Procedure)−preambleReceivedTargetPower−msg3-DeltaPreamble−messagePowerOffsetGroupB:
   The UE performs small data transmission using 4 step RA. Group B is selected.
Else
   The UE initiates 4 step RA for resuming connection (small data is not included).

This option can be generalized wherein the gNB configures the parameters sdt-TBS-group1 and sdt-TBS-groupN; messagePowerOffsetGroup1 to messagePowerOffsetGroupN, preambles for groups 1 to N.
If the message size (UL data available for transmission plus MAC header and, where required, MAC control elements) is less than or equal to the TB size signaled in sdt-TBS-group1 and the pathloss is less than PCMAX (of the Serving Cell performing the RA Procedure)−preambleReceivedTargetPower−msg3-DeltaPreamble−messagePowerOffsetGroup1:
   The UE performs small data transmission using 4 step RA. Group 1 is selected.
Else if the message size (UL data available for transmission plus MAC header and, where required, MAC control elements) is greater than TB size signaled in sdt-TBS-group1 and is less than or equal to the TB size signaled in sdt-TBS-group2 for the selected UL carrier and the pathloss is less than PCMAX (of the Serving Cell performing the RA Procedure)−preambleReceivedTargetPower−msg3-DeltaPreamble−messagePowerOffsetGroup2:
   The UE performs small data transmission using 4 step RA. Group 2 is selected.
Else if the message size (UL data available for transmission plus MAC header and, where required, MAC control elements) is greater than TB size signaled in sdt-TBS-group2 and is less than or equal to the TB size signaled in sdt-TBS-group3 for the selected UL carrier and the pathloss is less than PCMAX (of the Serving Cell performing the RA Procedure)−preambleReceivedTargetPower−msg3-DeltaPreamble−messagePowerOffsetGroup3:

The UE performs small data transmission using 4 step RA. Group 3 is selected.
Else if the message size (UL data available for transmission plus MAC header and, where required, MAC control elements) is greater than TB size signaled in sdt-TBS-groupN−1 and is less than or equal to the TB size signaled in sdt-TBS-groupN for the selected UL carrier and the pathloss is less than PCMAX (of the Serving Cell performing the RA Procedure)−preambleReceivedTargetPower−msg3-DeltaPreamble−messagePowerOffsetGroupN:
   The UE performs small data transmission using 4 step RA. Group N is selected.
Else:
   The UE initiates 4 step RA for resuming connection (small data is not included).

Option 6: Multiple [TBS, Preamble Group].

The gNB configures the parameters sdt-TBS-groupA and sdt-TBS-groupB which indicate the maximum allowed transport block sizes for small data transmission using 4 step RA for preamble group A and preamble group B, respectively. These parameters are separately configured for SUL and NUL as UL coverage is different for SUL and NUL.
If the message size (UL data available for transmission plus MAC header and, where required, MAC control elements) is less than or equal to the TB size signaled in sdt-TBS-groupA:
   The UE performs small data transmission using 4 step RA. Group A is selected.
Else if the message size (UL data available for transmission plus MAC header and, where required, MAC control elements) is greater than TB size signaled in sdt-TBS-groupA and is less than or equal to the TB size signaled in sdt-TBS-groupB for the selected UL carrier:
   The UE performs small data transmission using 4 step RA. Group B is selected.
Else
   The UE initiates 4 step RA for resuming connection (small data is not included).

This option can be generalized wherein the gNB configures the parameters sdt-TBS-group1 and sdt-TBS-groupN, preambles for groups 1 to N.
If the message size (UL data available for transmission plus MAC header and, where required, MAC control elements) is less than or equal to the TB size signaled in sdt-TBS-group1:
   The UE performs small data transmission using 4 step RA. Group 1 is selected.
Else if the message size (UL data available for transmission plus MAC header and, where required, MAC control elements) is greater than TB size signaled in sdt-TBS-group1 and is less than or equal to the TB size signaled in sdt-TBS-group2 for the selected UL carrier:
   The UE performs small data transmission using 4 step RA. Group 2 is selected.
Else if the message size (UL data available for transmission plus MAC header and, where required, MAC control elements) is greater than TB size signaled in sdt-TBS-group2 and is less than or equal to the TB size signaled in sdt-TBS-group3 for the selected UL carrier:
   The UE performs small data transmission using 4 step RA. Group 3 is selected.
Else if the message size (UL data available for transmission plus MAC header and, where required, MAC control elements) is greater than TB size signaled in sdt-TBS-groupN−1 and is less than or equal to the TB size signaled in sdt-TBS-groupN for the selected UL:
   The UE performs small data transmission using 4 step RA. Group N is selected.
Else:
   The UE initiates 4 step RA for resuming connection (small data is not included).

Note: separate msg3-DeltaPreamble could be configured per TBS in the above procedure.

### Embodiment 3—2 Step RA Based Small Data Transmission

3.1 Overall Procedure.

The objective is to enable small data transmission in RRC_INACTIVE state. The uplink data is transmitted in MsgA when 2 step RA procedure is used for small data transmission. It is not sufficient to transmit only uplink data in MsgA. Along with the uplink data, additional information (such as those listed below) also must be transmitted:
Resume Identity (short or full I-RNTI) to identity the UE's context and last serving gNB (if the gNB to which UE is transmitting UL data is different from the gNB where the UE has last received RRCRelease with suspend configuration). The gNB can indicate (e.g., in system information or RRC message) whether the UE should transmit short or full I-RNTI as the resume identity.
Authentication token (i.e., resumeMAC-I) to authenticate the UE.

To carry the above information, RRCResumeRequest/RRCResumeRequest1 message can be transmitted along with uplink data, wherein the RRCResumeRequest is transmitted if the Short I-RNTI is to be transmitted to the gNB, and the RRCResumeRequest1 is transmitted if the full I-RNTI is to be transmitted to the gNB. RRCResumeRequest/RRCResumeRequest1 are transmitted on SRB0 and hence they are not protected. The resumeMAC-I is generated using the RRC integrity key from the previous RRC connection. The RRC integrity key from the previous RRC connection is available from a stored AS context, wherein the UE stores the AS context when the UE enters RRC_INACTIVE upon receiving the RRCRelease message with suspendConfig.

Upon receiving the uplink data together with the RRCResumeRequest/RRCResumeRequest1 message, the gNB can send RRCRelease indicating the completion of small data transmission and the UE remains in RRC_INACTIVE. If the gNB has DL data, it can be sent together with RRCRelease. If the gNB has more DL data or is aware of more UL data in the UE, the gNB can send RRCResume instead of RRCRelease. RRCRelease and RRCResume are transmitted on SRB 1. They are both ciphered and integrity protected using the security keys (K_{RRCenc} for ciphering and K_{RRCint} for integrity protection) delivered according to an NCC received in the RRCRelease message of the previous RRC connection. The user data in uplink and downlink are ciphered and integrity protected (only for DRBs which are configured with integrity protection enabled) using the security keys (K_{UPenc} for ciphering and K_{UPint} for integrity protection) derived according to the NCC received in the RRCRelease message of the previous RRC connection.

3.1.1 Signaling Flow without Context Fetch.

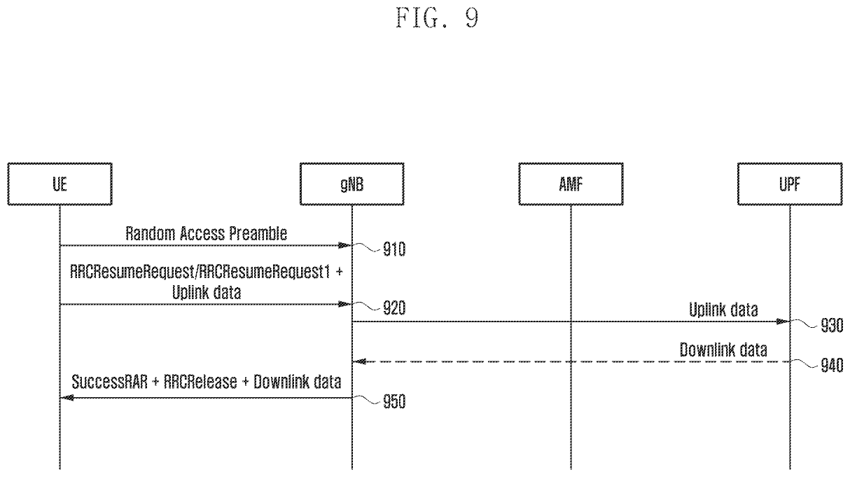

FIG. 9 illustrates another example of signaling flow for small data transmission according to an embodiment of the disclosure.

Referring to FIG. 9, it shows the signaling flow for small data transmission using 2 step RA. In this embodiment, it is assumed that the gNB has the UE's context.

The UE is in RRC_INACTIVE state. Criteria to initiate 2 step RA for SDT is met (when the UE is in RRC_INACTIVE state and neither the SDT procedure nor a connection resume procedure is ongoing, the SDT procedure can be initiated if data becomes available only for RB(s) for which SDT is allowed. If data becomes available for RB(s) for which SDT is not allowed, the UE initiates an RRC connection resume procedure wherein the data is transmitted/received from the gNB after entering the RRC_CONNECTED, data is not transmitted/received during the connection resume procedure and common RA resources are used for RA initiated for RRC connection resume procedure. The gNB indicates (e.g., in an RRCRelease message or RRCReconfiguration message) for which RB(s) SDT is allowed. See section 3.1.5 below for further details). The UE selects an SSB and a preamble/RO/PO from preambles/ROs/POs for SDT (as defined in 3.1.3 and 3.1.4 below for details). The UE transmits the RA preamble at operation 910. Note that the UE will select the UL carrier (SUL or NUL) when the RA procedure is initiated.

In the MsgA payload, the UE sends an RRCResumeRequest/RRCResumeRequest1 to the gNB (i.e., the last serving gNB) on SRB 0 at operation 920. It includes full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA or EIA) in the stored AS security context, which was negotiated between the UE and the last serving gNB and the K_{RRCint} from the stored AS security context with the following inputs:
KEY: shall be set to current K_{RRCint};
BEARER: all bits shall be set to 1;
DIRECTION: bit shall be set to 1;
COUNT: all bits shall be set to 1;
MESSAGE: shall be set to VarResumeMAC-Input with following inputs:
   source PCI (set to the physical cell identity of the PCell the UE was connected to prior to suspension of the RRC connection);
   target Cell-ID (set to the cellIdentity of the first PLMN-Identity included in the PLMN-IdentityInfoList broadcast in SIB 1 of the target cell, i.e., the cell to which the UE is sending small data);
   source C-RNTI (set to the C-RNTI that the UE had in the PCell it was connected to prior to suspension of the RRC connection).

The UE resumes SRBs and DRBs, derives new security keys using the NCC provided in the RRCRelease message of the previous RRC connection and re-establishes the AS security. The user data is ciphered and integrity protected (only for DRBs configured with UP integrity protection) using the security keys (K_{UPint} key for integrity protection and the K_{UPenc} key for ciphering) and transmitted on a DTCH multiplexed with the RRCResumeRequest/RRCResumeRequest1 message on the CCCH.

The gNB validates the resumeMAC-I. If the verification of the ResumeMAC-I is successful, then the gNB calculates K_{NG-RAN}* using the target cell PCI, target ARFCN-DL, and the K_{gNB}/NH in the current UE 5G AS security context based on either a horizontal key derivation or a vertical key derivation according to the NCC which was sent to the UE in the release message of the previous RRC connection. The gNB can obtain the target PCI and target ARFCN-DL from a cell configuration database by means of the target Cell-ID which was received from the UE in the resume message. The gNB derives new security keys (K_{RRCenc} key, the K_{RRCint} key, K_{UPint} key and the K_{UPenc} key). The gNB decrypts the uplink data and verifies MAC I (if the uplink data is integrity protected) and delivers the uplink data to the UPF at operation 930. Note that this procedure is same as in case of context fetch except that source gNB and target gNB are same in this case.

The gNB sends the RRCRelease message to keep the UE in RRC_INACTIVE in MsgB along with successRAR. The PDCCH is addressed to the C-RNTI. If downlink data is available, it is sent ciphered and integrity protected (only for DRBs configured with UP integrity protection) using the security keys (K_{UPint} key for integrity protection and the K_{UPenc} key for ciphering) on a DTCH multiplexed with the RRCRelease message on DCCH at operations 940 and 950.

In an alternate embodiment, RRCRelease is not sent along with successRAR, but is sent later. In between transmission of MsgB and transmission of the RRCRelease message, the gNB can schedule an UL grant (a PDCCH addressed to the C-RNTI, i.e., C-RNTI received in MsgB). Note that the UE continues to remain in RRC_INACTIVE state after the MsgB transmission. The user data transmitted/received in between reception of MsgB and reception of RRCRelease message is ciphered and integrity protected (only for DRBs configured with UP integrity protection) using the security keys (K_{UPint} key for integrity protection and the K_{UPenc} key for ciphering) In the UL transmission the UE can indicate if it has more data to transmit. If the UE has more data to transmit, the gNB can schedule an UL grant, otherwise RRCRelease. In the UL transmission, the UE can also include SSB ID(s) of an SSB above threshold if the SSB indicated by PRACH preamble is no longer suitable.

3.1.2 Signaling Flow with Context Fetch and Path Switching.

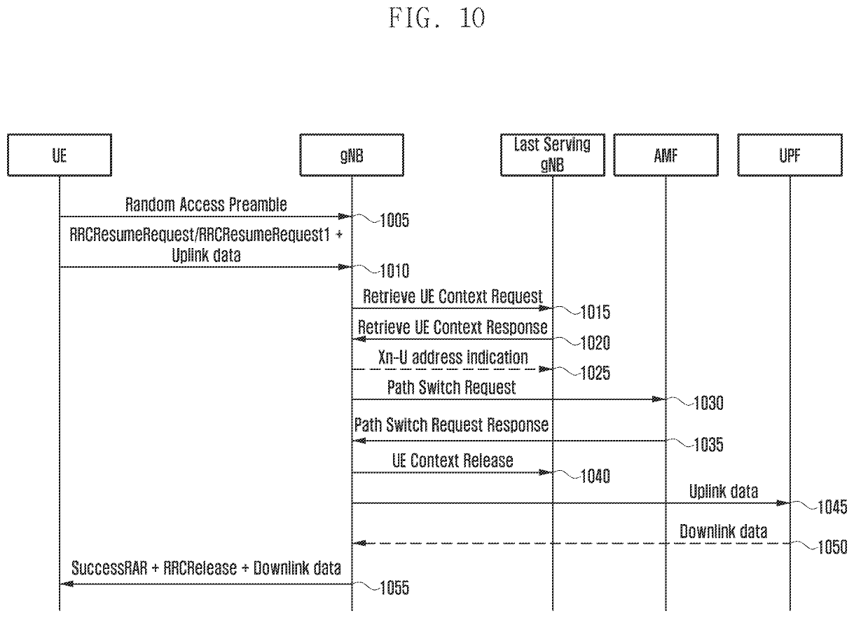

FIG. 10 illustrates another example of signaling flow for small data transmission according to an embodiment of the disclosure.

Referring to FIG. 10, it shows the signaling flow for small data transmission using 2 step RA. In this embodiment, it is assumed that the gNB does not have the UE's context and fetches the context from the last serving gNB. Path switch is performed and the context is released from the last serving gNB.

The UE is in RRC_INACTIVE state. Criteria to initiate 2 step RA for SDT are met (when the UE is in RRC_INACTIVE state and neither the SDT procedure nor connection resume procedure is ongoing, the SDT procedure is initiated if data becomes available only for RB(s) for which SDT is allowed. If data becomes available for RB(s) for which SDT is not allowed, the UE initiates a connection resume procedure wherein the data is transmitted/received from the gNB after entering the RRC_CONNECTED, the data is not transmitted/received during the connection resume procedure and common RA resources are used for RA initiated for the RRC connection resume procedure. The gNB indicates (e.g., in an RRCRelease message or RRCReconfiguration message) for which RB(s) SDT is allowed. See section 3.1.5 below for further details). The UE selects a preamble/RO/PO from preambles/ROs/POs for SDT. The UE transmits the RA preamble at operation 1005. Note that the UE will select a UL carrier (SUL or NUL) when the RA procedure is initiated.

In the MsgA payload, the UE sends an RRCResumeRequest/RRCResumeRequest1 to the gNB (different from the last serving gNB) on SRB 0 at operation 1010. It includes full/short I-RNTI (resumeIdentity), the resume cause (resumeCause), and an authentication token (resumeMAC-I). The I-RNTI (short or full I-RNTI) is used for context identification and its value shall be the same as the I-RNTI that the UE had received from the last serving gNB in the RRCRelease with suspendConfig message. The ResumeMAC-I is a 16-bit message authentication token, the UE shall calculate it using the integrity algorithm (NIA or EIA) in the stored AS security context, which was negotiated between the UE and the last serving gNB and the K_{RRCint} from the stored AS security context with the following inputs:
KEY: shall be set to current K_{RRCint};
BEARER: all bits shall be set to 1;
DIRECTION: bit shall be set to 1;
COUNT: all bits shall be set to 1;
MESSAGE: shall be set to VarResumeMAC-Input with following inputs:
   source PCI (set to the physical cell identity of the PCell the UE was connected to prior to suspension of the RRC connection);
   target Cell-ID (set to the cellIdentity of the first PLMN-Identity included in the PLMN-IdentityInfoList broadcast in SIB1 of the target cell, i.e., the cell the UE is trying to resume);
   source C-RNTI (set to C-RNTI that the UE had in the PCell it was connected to prior to suspension of the RRC connection).

The UE resumes SRBs and DRBs, derives new security keys using the NCC provided in the RRCConnectionRelease message of the previous RRC connection and re-establishes the AS security. The user data are ciphered and integrity protected (only for DRBs configured with UP integrity protection) using the security keys (K_{UPint} key for integrity protection and the K_{UPenc} key for ciphering) and transmitted on a DTCH multiplexed with the RRCResumeRequest/RRCResumeRequest1 message on CCCH.

The gNB (i.e., a target gNB) identifies the gNB identity of last serving gNB (i.e., the source gNB) from the I-RNTI and requests it to provide the UE's context data by sending a Retrieve UE Context Request message with the following included: the I-RNTI, the ResumeMAC-I, and the target Cell-ID, in order to allow the source gNB to validate the UE request and to retrieve the UE context at operation 1015.

The last serving gNB (i.e., the source gNB) validates the resumeMAC-I and provides the UE context data.

The source gNB retrieves the stored UE context including the UE 5G AS security context from its database using the I-RNTI. The source gNB verifies the ResumeMAC-I using the current K_{RRCint} key stored in the retrieved UE 5G AS security context (calculating the ResumeMAC-I as described above). If the verification of the ResumeMAC-I is successful, then the source gNB calculates K_{NG-RAN}* using the target cell PCI, target ARFCN-DL and the K_{gNB}/NH in the current UE 5G AS security context based on either a horizontal key derivation or a vertical key derivation according to whether the source gNB has an unused pair of {NCC, NH}. The source gNB can obtain the target PCI and target ARFCN-DL from a cell configuration database by means of the target Cell-ID which was received from the target gNB. Then the source gNB shall respond with an Xn-AP Retrieve UE Context Response message to the target gNB including the UE context that contains the UE 5G AS security context at operation 1020. The UE 5G AS security context sent to the target gNB shall include the newly derived K_{NG-RAN}*, the NCC associated to the K_{NG-RA}N*, the UE 5G security capabilities, UP security policy, the UP security activation status with the corresponding PDU session ID(s), and the ciphering and integrity algorithms used by the UE with the source cell.

To prevent loss of DL user data buffered in the last serving gNB, the gNB provides forwarding addresses at operation 1025.

The gNB performs path switch at operations 1030 and 1035.

The gNB triggers the release of the UE resources at the last serving gNB at operation 1040.

The gNB delivers the uplink data to the UPF at operation 1045.

The gNB sends the RRCRelease message to keep the UE in RRC_INACTIVE in MsgB along with successRAR. The PDCCH is addressed to the C-RNTI. If downlink data is available, it is sent ciphered and integrity protected (only for DRBs configured with UP integrity protection) using the security keys (K_{UPint} key for integrity protection and the K_{UPenc} key for ciphering) on a DTCH multiplexed with the RRCRelease message on DCCH at operations 1050 and 1055.

3.1.3 ROs for SDT Using 2 Step RA.

2 step ROs for SDT can be shared with 2 step ROs for non SDT or can be separately configured. The following parameters are signaled by the gNB for configuring ROs for small data transmission using 2 step RA.
msgA-PRACH-ConfigurationIndex-SDT:
   PRACH configuration index for SDT using 2 step RA. The gNB has the option to not signal msgA-PRACH-ConfigurationIndex-SDT. If msgA-PRACH-ConfigurationIndex-SDT is not signaled by the gNB, the UE determines PRACH occasions for 2 step RA based SDT according to msgA-PRACH-ConfigurationIndex configured/signaled by the gNB for non SDT (i.e., in RACH-ConfigGenericTwoStepRA). This field may only be present in the case of separate ROs for 2 step RA based SDT.
msgA-RO-FDM-SDT:
   The number of msgA PRACH transmission occasions FDMed in one time instance for SDT using 2 step RA. If the field is absent, the UE shall use the value of msgA-RO-FDM in RACH-ConfigGenericTwoStepRA. This field may only be present in the case of separate ROs for 2 step RA based SDT.
msgA-RO-FrequencyStart-SDT:
   Offset of lowest PRACH transmissions occasion in the frequency domain with respect to PRB 0. If the field is absent, the UE shall use the value of msgA-RO-FrequencyStart in RACH-ConfigGenericTwoStepRA. This field may only be present in the case of separate ROs for 2 step RA based SDT.

For flexible signaling of ROs for SDT, the following parameters of Table 2 can be configured in RACH configuration for SDT using 2 step RA.

TABLE 2
prach-ConfigurationPeriodScaling-SDT
Scaling factor to extend the periodicity of the baseline configuration
indicated by prach-ConfigurationIndex. Value scf1 corresponds to
scaling factor of 1, etc.
prach-ConfigurationFrameOffset-SDT
Scaling factor for ROs defined in the baseline configuration indicated
by prach-ConfigurationIndex.
prach-ConfigurationSOffset-SDT
Subframe/Slot offset for ROs defined in the baseline configuration
indicated by prach-ConfigurationIndex.

3.1.4 RA Preambles for SDT Using 2 Step RA.

The following options are supported for determining preambles for SDT:
Option 1: 2 step ROs used for SDT are same as 2 step ROs for non SDT.
   Case 1: 4 step RA is configured but ROs for 2 step RA are not shared with 4 step RA;
   ssb-perRACH-Occasion (N1) is configured for 2 step RA;
   CB-PreamblesPerSSB (R1) is configured for 2 step RA;
   CB-PreamblesPerSSB-SDT (X) is configured for SDT using 2 step RA;
   if N1<1, one SS/PBCH block is mapped to 1/N1 consecutive valid PRACH occasions and X contention based preambles with consecutive indexes associated with the SS/PBCH block per valid PRACH occasion start from preamble index R1. If N1≥1, X contention based preambles with consecutive indexes associated with SS/PBCH block n, 0≤n≤N1−1, per valid PRACH occasion start from preamble index n·N_{preamble}^{total}/N1+R1, where N_{preamble}^{total} is provided by totalNumberOfRA-Preambles for 2 step RA procedure. If totalNumberOfRA-Preambles is not configured, the UE assumes a value, e.g., 64.
   Case 2: 4 step RA is configured and ROs for 2 step RA are shared with 4 step RA, 4 step RA for SDT is also configured and ROs for 4 step RA based SDT is not same as ROs for 4 step RA
      ssb-perRACH-Occasion (N1) is configured for 4 step RA;
      CB-PreamblesPerSSB (R1) is configured for 4 step RA;
      CB-PreamblesPerSSB (R2) is configured for 2 step RA;
      CB-PreamblesPerSSB-SDT (X) is configured for SDT using 2 step RA;
      if N1<1, one SS/PBCH block is mapped to 1/N1 consecutive valid PRACH occasions and X contention based preambles with consecutive indexes associated with the SS/PBCH block per valid PRACH occasion start from preamble index R1+R2. If N1≥1, X contention based preambles with consecutive indexes associated with SS/PBCH block n, 0≤n≤N1−1, per valid PRACH occasion start from preamble index n·N_{preamble}^{total}/N1+R1+R2, where N_{preamble}^{total} is provided by totalNumberOfRA-Preambles for 4 step RA procedure. If totalNumberOfRA-Preambles is not configured, UE assumes a value, e.g., 64.
   Case 3: 4 step RA is configured and ROs for 2 step RA are shared with 4 step RA, 4 step RA for SDT is also configured and ROs for 4 step RA based SDT is same as ROs for 4 step RA:
      ssb-perRACH-Occasion (N1) configured for 4 step RA
      CB-PreamblesPerSSB (R1) configured for 4 step RA
      CB-PreamblesPerSSB (R2) configured for 2 step RA
      CB-PreamblesPerSSB (R3) configured for SDT using 4 step RA
      CB-PreamblesPerSSB-SDT (X) is configured for SDT using 2 step RA
      if N1<1, one SS/PBCH block is mapped to 1/N1 consecutive valid PRACH occasions and X contention based preambles with consecutive indexes associated with the SS/PBCH block per valid PRACH occasion start from preamble index R1+R2+R3. If N1≥1, X contention based preambles with consecutive indexes associated with SS/PBCH block n, 0≤n≤N1−1, per valid PRACH occasion start from preamble index n·N_{preamble}^{total}/N1+R1+R2+R3, where N_{preamble}^{total} is provided by totalNumberOfRA-Preambles for 4 step RA procedure. If totalNumberOfRA-Preambles is not configured, UE assumes the value is 64.
   Alternate option to cover both case 1 and case 2
      CB-PreamblesPerSSB-SDT (X) is configured for SDT using 2 step RA
      ssb-perRACH-Occasion (N1) configured for 2 step RA
      Starting preamble index (S) for SDT using 2 step RA is configured
      if N1<1, one SS/PBCH block is mapped to 1/N1 consecutive valid PRACH occasions and X contention based preambles with consecutive indexes associated with the SS/PBCH block per valid PRACH occasion start from preamble index S. If N1≥1, X contention based preambles with consecutive indexes associated with SS/PBCH block n, 0≤n≤N1−1, per valid PRACH occasion start from preamble index n·N_{preamble}^{total}/N1+S, where N_{preamble}^{total} is provided by totalNumberOfRA-Preambles for 2 step RA procedure.
Option 2: 2 step ROs used for SDT are different from 2 step ROs for non SDT.
   CB-PreamblesPerSSB-SDT (X) is configured for SDT using 2 step RA
   ssb-perRACH-Occasion-SDT (Y) is configured for SDT using 2 step RA
   if Y<1, one SS/PBCH block is mapped to 1/Y consecutive valid PRACH occasions and X contention based preambles with consecutive indexes associated with the SS/PBCH block per valid PRACH occasion start from preamble index 0. If Y≥1, X contention based preambles with consecutive indexes associated with SS/PBCH block n, 0≤n≤Y−1, per valid PRACH occasion start from preamble index n·N_{preamble}^{total}/Y, where N_{preamble}^{total} is provided by totalNumberOfRA-Preambles for SDT 2 step RA procedure. If totalNumberOfRA-Preambles for SDT 2 step RA procedure is not configured, UE assumes the value is 64.
Simple option to cover both shared (option 1) and non shared (option 2)
   Starting preamble index (S) for SDT using 2 step RA is configured
   CB-PreamblesPerSSB-SDT (X) is configured for SDT using 2 step RA
   ssb-perRACH-Occasion-SDT (Y) is configured for SDT using 2 step RA
   if Y<1, one SS/PBCH block is mapped to 1/Y consecutive valid PRACH occasions and X contention based preambles with consecutive indexes associated with the SS/PBCH block per valid PRACH occasion start from preamble index S. If Y≥1, X contention based preambles with consecutive indexes associated with SS/PBCH block n, 0≤n≤Y−1, per valid PRACH occasion start from preamble index n·N_{preamble}^{total}/Y+S, where N_{preamble}^{total} is provided by totalNumberOfRA-Preambles for SDT 4 step RA procedure. If totalNumberOfRA-Preambles for SDT 2 step RA procedure is not configured, UE assumes the value is 64.

NOTE 9: The RACH parameters for small data transmission are configured for initial UL BWP (separately for NUL and SUL). If any other UL BWP is used for SDT, RACH parameters for small data transmission can also be configured for those UL BWPs as well. If multiple preamble groups are supported for small data transmission, information to determine number of preambles per group is also configured in the RACH parameters for small data transmission. Other parameters such as MsgB window, power ramping step, received target power, etc., can also be configured in the RACH parameters for small data transmission and if not configured, UE applies the corresponding parameters from RACH-ConfigGenericTwoStepRA for 4 step RA.

Separate BWP for SDT can be configured. As initial BWP could be narrow while SDT may requires wider BW. Alternately, UL grant in RAR can indicate RBs outside initial BWP.

3.1.5 Criteria to Determine Whether to Use 2 Step RA for SDT or not.

UE select the UL carrier, UL BWP and RA Type as described earlier. Here it is assumed that 2 step RA is selected. The UE can perform SDT using 2 step RA if the following condition(s) are met. Otherwise UE perform connection resume procedure without SDT. Note that in an embodiment UE may apply a subset of conditions below to determine whether to perform SDT.

Cond 1: the upper layers request resumption of an RRC connection and the resumption request is for mobile originating calls and the establishment cause is mo-Data;

Cond 2: the UE supports SDT;

Cond 3: system information includes SDT configuration for 2 step RA;

Cond 4: UE has a stored value of the nextHopChainingCount provided in the RRCRelease message with suspend indication during the preceding suspend procedure; In an embodiment, where the nextHopChainingCount is always provided in the RRCRelease message with suspend indication and UE always stores it, this condition is not required to be checked.

Cond 5: RRCRelease message with suspend indication during the preceding suspend procedure indicates that UE is allowed to perform SDT using 2 step RA

In order to control the UEs which can perform SDT, network can indicate whether UE is allowed to perform SDT or not in RRCRelease. If not allowed, UE will perform connection resume. Indication can be common for all methods of SDT. Indication can be separate for 4 step RA, 2 step RA.

Cond 6: If the LCH restrictions for LCP are applied for SDT and all LCHs for which data is available for transmission is allowed to be multiplexed in MsgA according to LCH restrictions.

Network (i.e., gNB) can also indicate the radio bearers (RBs) for which SDT is allowed. GNB can inform this using RRCRelease message or RRCReconfiguration message while UE is in RRC_CONNECTED. In this case in Cond 6, LCHs corresponding to the RBs for which SDT is allowed is considered. While the UE is in RRC_INACTIVE, if data is available for transmission for RBs other than RBs for which SDT is allowed, UE shall initiate connection resume without SDT.

Cond 7: MsgA TBS and signal quality threshold criteria as explained below is met. One of the following options can be used to configure MsgA TBS for SDT and to determine whether to use 2 step RA for small data transmission or normal connection resume.

Option 1: Single MsgA PUSCH Configuration, No Signal Quality Based Threshold

gNB configures a single MsgA-PUSCH-Config-SDT (i.e. a PUSCH resource pool) in 2 step RA configuration for SDT. The TBS is not explicitly signaled but determined based on SCS, number of PRBs and number of OFDM symbols of PO.
If the message size (UL data available for transmission plus MAC header and, where required, MAC control elements) is less than equal to the TB size of MsgA payload according to MsgA-PUSCH-Config-SDT on UL carrier selected for RA procedure:
   UE initiate 2 step RA for small data transmission. Preamble group selection is not performed during this RA procedure.
Else
   UE initiate 2 step RA for resuming connection (small data is not included)

Option 2: Single MsgA PUSCH Configuration, Single RSRP Threshold

gNB configures a single MsgA-PUSCH-Config-SDT (i.e. a PUSCH resource pool) in 2 step RA configuration for SDT. The TBS is not explicitly signaled but determined based on SCS, number of PRBs and number of OFDM symbols of PO. gNB also configures the parameter sdt-Threshold-MsgA. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT on UL carrier selected for RA procedure and RSRP of the downlink pathloss reference is greater than or equal to sdt-Threshold-MsgA:
   UE initiate 2 step RA for small data transmission. Preamble group selection is not performed during this RA procedure.
Else
   UE initiate 4 step RA for resuming connection (small data is not included)

Option 3: Multiple [MsgA PUSCH Configuration, Threshold, Preamble Group]

gNB configures the parameter MsgA-PUSCH-Config-SDT-groupA and MsgA-PUSCH-Config-SDT-group B in 2 step RA configuration for SDT. The TBS is not explicitly signaled but determined based on SCS, number of PRBs and number of OFDM symbols of PO. sdt-Threshold-MsgA-groupB is also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for RA procedure:
   UE perform small data transmission using 2 step RA. Group A is selected.
Else If the message size (UL data available for transmission plus MAC header and, where required, MAC control elements) is less than equal to the TB size of MsgA payload according to MsgA-PUSCH-Config-SDT-groupB for the selected UL carrier and RSRP of the downlink pathloss reference is greater than or equal to sdt-Threshold-MsgA-groupB
   UE perform small data transmission using 2 step RA. Group B is selected.
Else
   UE initiate 2 step RA for resuming connection (small data is not included)

This option can be generalized wherein gNB configures the parameters MsgA-PUSCH-Config-SDT-group1 to MsgA-PUSCH-Config-SDT-groupN; sdt-Threshold-MsgA-group2 to sdt-Threshold-MsgA-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for RA procedure:
   UE perform small data transmission using 2 step RA. Group 1 is selected.
Else If the message size (UL data available for transmission plus MAC header and, where required, MAC control elements) is less than equal to the TB size of MsgA payload according to MsgA-PUSCH-Config-SDT-group2 for SDT on UL carrier selected for RA procedure and RSRP of the downlink pathloss reference is greater than or equal to sdt-Threshold-MsgA-group2
   UE perform small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (is greater than TB size of MsgA payload according to MsgA-PUSCH-Config-SDT-group2 and can be removed in one embodiment) is less than equal to the TB size of MsgA payload according to MsgA-PUSCH-Config-SDT-group3 for SDT on UL carrier selected for RA procedure and RSRP of the downlink pathloss reference is greater than or equal to sdt-Threshold-MsgA-group3
   UE perform small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN−1 and (is greater than TB size of MsgA payload according to MsgA-PUSCH-Config-SDT-groupN−1 and can be removed in one embodiment) is less than equal to the TB size of MsgA payload according to MsgA-PUSCH-Config-SDT-groupN for SDT on UL carrier selected for RA procedure and RSRP of the downlink pathloss reference is greater than or equal to sdt-Threshold-MsgA-groupN
   UE perform small data transmission using 2 step RA. Group N is selected.
Else:
   UE initiate 2 step RA for resuming connection (small data is not included)

Option 3A:

gNB configures the parameters MsgA-PUSCH-Config-SDT-groupA and MsgA-PUSCH-Config-SDT-in 2 step RA configuration for SDT. The TBS is not explicitly signaled but determined based on SCS, number of PRBs and number of OFDM symbols of PO. sdt-Threshold-MsgA-groupA and sdt-Threshold-MsgA-groupB are also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for RA procedure and RSRP of the downlink pathloss reference is greater than or equal to sdt-Threshold-MsgA-groupA:
   UE perform small data transmission using 2 step RA. Group A is selected.
Else If the message size (UL data available for transmission plus MAC header and, where required, MAC control elements) is greater than TB size of MsgA payload according to MsgA-PUSCH-Config-SDT-groupA and (is greater than TB size of MsgA payload according to MsgA-PUSCH-Config-SDT-groupA and can be removed in one embodiment) is less than equal to the TB size of MsgA payload according to MsgA-PUSCH-Config-SDT-groupB for the selected UL carrier and RSRP of the downlink pathloss reference is greater than or equal to sdt-Threshold-MsgA-groupB
   UE perform small data transmission using 2 step RA. Group B is selected.
Else
   UE initiate 2 step RA for resuming connection (small data is not included)

This option can be generalized wherein gNB configures the parameters MsgA-PUSCH-Config-SDT-group1 to MsgA-PUSCH-Config-SDT-groupN; sdt-Threshold-MsgA-group1 to sdt-Threshold-MsgA-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for RA procedure and RSRP of the downlink pathloss reference is greater than or equal to sdt-Threshold-MsgA-group1:
   UE perform small data transmission using 2 step RA. Group 1 is selected.
Else If the message size (UL data available for transmission plus MAC header and, where required, MAC control elements) is greater than TB size of MsgA payload according to MsgA-PUSCH-Config-SDT-group1 and (is greater than TB size of MsgA payload according to MsgA-PUSCH-Config-SDT-group1 and can be removed in one embodiment) is less than equal to the TB size of MsgA payload according to MsgA-PUSCH-Config-SDT-group2 for SDT on UL carrier selected for RA procedure and RSRP of the downlink pathloss reference is greater than or equal to sdt-Threshold-MsgA-group2
   UE perform small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (is greater than TB size of MsgA payload according to MsgA-PUSCH-Config-SDT-group2 and can be removed in one embodiment) is less than equal to the TB size of MsgA payload according to MsgA-PUSCH-Config-SDT-group3 for SDT on UL carrier selected for RA procedure and RSRP of the downlink pathloss reference is greater than or equal to sdt-Threshold-MsgA-group3
   UE perform small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN−1 and (is greater than TB size of MsgA payload according to MsgA-PUSCH-Config-SDT-groupN−1 and can be removed in one embodiment) is less than equal to the TB size of MsgA payload according to MsgA-PUSCH-Config-SDT-groupN for SDT on UL carrier selected for RA procedure and RSRP of the downlink pathloss reference is greater than or equal to sdt-Threshold-MsgA-groupN
   UE perform small data transmission using 2 step RA. Group N is selected.
Else:
   UE initiate 2 step RA for resuming connection (small data is not included)

Option 4: Single MsgA PUSCH Configuration, Single msgA-messagePowerOffsetSDT for Pathloss Threshold

gNB configures a single MsgA-PUSCH-Config-SDT (i.e. a PUSCH resource pool) in 2 step RA configuration for SDT. The TBS is not explicitly signaled but determined based on SCS, number of PRBs and number of OFDM symbols of PO. gNB also configures the parameter msgA-messagePowerOffsetSDT. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA PUSCH configuration for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffsetSDT:
   UE initiates 2 step RA for small data transmission.
Else
   UE initiate 2 step RA for resuming connection (small data is not included)

Option 5: Multiple [MsgA PUSCH Configuration, msgA-messagePowerOffsetSDT, Preamble Group]

The gNB configures the parameters MsgA-PUSCH-Config-SDT-groupA and MsgA-PUSCH-Config-SDT-in 2 step RA configuration for SDT. The TBS is not explicitly signaled but determined based on SCS, number of PRBs and number of OFDM symbols of PO. msgA-messagePowerOffset-groupB is also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for RA procedure:
   UE perform small data transmission using 2 step RA. Group A is selected.
Else If the message size (UL data available for transmission plus MAC header and, where required, MAC control elements) is greater than TB size of MsgA payload according to MsgA-PUSCH-Config-SDT-groupA and (is greater than TB size of MsgA payload according to MsgA-PUSCH-Config-SDT-groupA and can be removed in one embodiment) is less than equal to the TB size of MsgA payload according to MsgA-PUSCH-Config-SDT-groupB for the selected UL carrier and the pathloss is less than PCMAX (of the Serving Cell performing the RA Procedure)−msgA-preambleReceivedTargetPower−msgA-DeltaPreamble−msgA-messagePowerOffset-groupB
   UE perform small data transmission using 2 step RA. Group B is selected.
Else
   UE initiate 2 step RA for resuming connection (small data is not included)

This option can be generalized wherein gNB configures the parameters MsgA-PUSCH-Config-SDT-group1 to MsgA-PUSCH-Config-SDT-groupN; msgA-messagePowerOffset-group2 to msgA-messagePowerOffset-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for RA procedure:
   UE perform small data transmission using 2 step RA. Group 1 is selected.
Else If the message size (UL data available for transmission plus MAC header and, where required, MAC control elements) is greater than TB size of MsgA payload according to MsgA-PUSCH-Config-SDT-group1 and (is greater than TB size of MsgA payload according to MsgA-PUSCH-Config-SDT-group1 and can be removed in one embodiment) is less than equal to the TB size of MsgA payload according to MsgA-PUSCH-Config-SDT-group2 for SDT on UL carrier selected for random access procedure and the pathloss is less than PCMAX (of the Serving Cell performing the RA Procedure)−msgA-preambleReceivedTargetPower−msgA-DeltaPreamble−msgA-messagePowerOffset-group2
   UE perform small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (is greater than TB size of MsgA payload according to MsgA-PUSCH-Config-SDT-group1 and can be removed in one embodiment) is less than equal to the TB size of MsgA payload according to MsgA-PUSCH-Config-SDT-group3 for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffset-group2
   UE perform small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN−1 and (is greater than TB size of MsgA payload according to MsgA-PUSCH-Config-SDT-groupN−1 and can be removed in one embodiment) is less than equal to the TB size of MsgA payload according to MsgA-PUSCH-Config-SDT-groupN for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffset-groupN
   UE perform small data transmission using 2 step RA. Group N is selected.
Else:
   UE initiate 2 step RA for resuming connection (small data is not included)

Option 5A:

The gNB configures the parameters MsgA-PUSCH-Config-SDT-groupA and MsgA-PUSCH-Config-SDT-in 2 step RA configuration for SDT. The TBS is not explicitly signaled but determined based on SCS, number of PRBs and number of OFDM symbols of PO. msgA-messagePowerOffset-groupB and msgA-messagePowerOffset-groupA is also configured. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffset-groupA:
   UE perform small data transmission using 2 step RA. Group A is selected.
Else If the message size (UL data available for transmission plus MAC header and, where required, MAC control elements) is greater than TB size of MsgA payload according to MsgA-PUSCH-Config-SDT-groupA and (is greater than TB size of MsgA payload according to MsgA-PUSCH-Config-SDT-groupA and can be removed in one embodiment) is less than equal to the TB size of MsgA payload according to MsgA-PUSCH-Config-SDT-groupB for the selected UL carrier and the pathloss is less than PCMAX (of the Serving Cell performing the RA Procedure)−msgA-preambleReceivedTargetPower−msgA-DeltaPreamble−msgA-messagePowerOffset-groupB
   UE perform small data transmission using 2 step RA. Group B is selected.
Else
   UE initiate 2 step RA for resuming connection (small data is not included)

This option can be generalized wherein gNB configures the parameters MsgA-PUSCH-Config-SDT-group1 to MsgA-PUSCH-Config-SDT-groupN; msgA-messagePowerOffset-group1 to msgA-messagePowerOffset-groupN, preambles for group 1 to N.
If the message size (UL data available for transmission plus MAC header and, where required, MAC control elements) is less than equal to the TB size of MsgA payload according to MsgA-PUSCH-Config-SDT-group1 for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffset-group1:
   UE perform small data transmission using 2 step RA. Group 1 is selected.
Else If the message size (UL data available for transmission plus MAC header and, where required, MAC control elements) is greater than TB size of MsgA payload according to MsgA-PUSCH-Config-SDT-group1 and (is greater than TB size of MsgA payload according to MsgA-PUSCH-Config-SDT-group1 and can be removed in one embodiment) is less than equal to the TB size of MsgA payload according to MsgA-PUSCH-Config-SDT-group2 for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffset-group2
   UE perform small data transmission using 2 step RA. Group 2 is selected.
Else If the message size (UL data available for transmission plus MAC header and, where required, MAC control elements) is greater than TB size of MsgA payload according to MsgA-PUSCH-Config-SDT-group2 and (is greater than TB size of MsgA payload according to MsgA-PUSCH-Config-SDT-group2 and can be removed in one embodiment) is less than equal to the TB size of MsgA payload according to MsgA-PUSCH-Config-SDT-group3 for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffset-group2
   UE perform small data transmission using 2 step RA. Group 3 is selected.
Else If the message size (UL data available for transmission plus MAC header and, where required, MAC control elements) is greater than TB size of MsgA payload according to MsgA-PUSCH-Config-SDT-groupN−1 and (is greater than TB size of MsgA payload according to MsgA-PUSCH-Config-SDT-groupN−1 and can be removed in one embodiment) is less than equal to the TB size of MsgA payload according to MsgA-PUSCH-Config-SDT-groupN for SDT on UL carrier selected for RA procedure and the pathloss is less than PCMAX (of the Serving Cell performing the RA Procedure)−msgA-preambleReceivedTargetPower−msgA-DeltaPreamble−msgA-messagePowerOffset-groupN
   UE perform small data transmission using 2 step RA. Group N is selected.
Else:
   UE initiate 2 step RA for resuming connection (small data is not included)

Option 6: Multiple [TBS, Preamble Group]

The gNB configures the parameters MsgA-PUSCH-Config-SDT-groupA and MsgA-PUSCH-Config-SDT-in 2 step RA configuration for SDT. The TBS is not explicitly signaled but determined based on SCS, number of PRBs and number of OFDM symbols of PO. These parameters are separately configured for SUL and NUL as UL coverage is different for SUL and NUL.
If the message size (UL data available for transmission plus MAC header and, where required, MAC control elements) is less than equal to the TB size of MsgA payload according to MsgA-PUSCH-Config-SDT-groupA:
   UE perform small data transmission using 2 step RA. Group A is selected.
Else If the message size (UL data available for transmission plus MAC header and, where required, MAC control elements) is less than equal to the TB size TB size of MsgA payload according to MsgA-PUSCH-Config-SDT-groupB.
   UE perform small data transmission using 2 step RA. Group B is selected.
Else
   UE initiate 4 step RA for resuming connection (small data is not included)

This option can be generalized wherein gNB configures the parameters MsgA-PUS CH-Config-SDT-group1 and MsgA-PUSCH-Config-SDT-groupN, preambles for group 1 to N.
If the message size (UL data available for transmission plus MAC header and, where required, MAC control elements) is less than equal to the TB size of MsgA payload according to MsgA-PUSCH-Config-SDT-group1:
   UE perform small data transmission using 4 step RA. Group 1 is selected.
Else If the message size (UL data available for transmission plus MAC header and, where required, MAC control elements) is less than equal to the TB size of MsgA payload according to MsgA-PUSCH-Config-SDT-group2
   UE perform small data transmission using 2 step RA. Group 2 is selected.
Else If the message size (UL data available for transmission plus MAC header and, where required, MAC control elements) is less than equal to the TB size of MsgA payload according to MsgA-PUSCH-Config-SDT-group3
   UE perform small data transmission using 2 step RA. Group 3 is selected.
Else If the message size (UL data available for transmission plus MAC header and, where required, MAC control elements) is less than equal to the TB size of MsgA payload according to MsgA-PUSCH-Config-SDT-groupN
   UE perform small data transmission using 2 step RA. Group N is selected.
Else:
   UE initiate 2 step RA for resuming connection (small data is not included)

Note: separate msgA-DeltaPreamble could be configured per TBS in the above procedure.

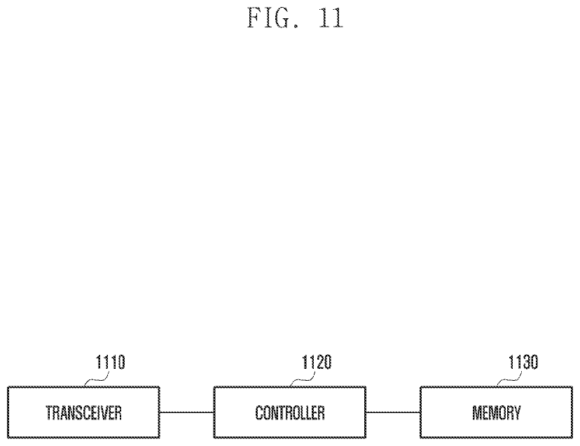

FIG. 11 is a block diagram of a terminal according to an embodiment of the disclosure.

Referring to FIG. 11, a terminal includes a transceiver 1110, a controller 1120 and a memory 1130. The controller 1120 may refer to a circuitry, an application-specific integrated circuit (ASIC), or at least one processor. The transceiver 1110, the controller 1120 and the memory 1130 are configured to perform the operations of the terminal illustrated in FIGS. 1 to 10, or described above. Although the transceiver 1110, the controller 1120 and the memory 1130 are shown as separate entities, they may be realized as a single entity like a single chip. Or, the transceiver 1110, the controller 1120 and the memory 1130 may be electrically connected to or coupled with each other.

The transceiver 1110 may transmit and receive signals to and from other network entities, e.g., a base station.

The controller 1120 may control the terminal to perform functions according to one of the embodiments described above. For example, the controller 1120 controls the transceiver 1110 and/or memory 1130 to perform small data transmission and reception according to various embodiments of the disclosure.

In an embodiment, the operations of the terminal may be implemented using the memory 1130 storing corresponding program codes. Specifically, the terminal may be equipped with the memory 1130 to store program codes implementing desired operations. To perform the desired operations, the controller 1120 may read and execute the program codes stored in the memory 1130 by using at least one processor or a CPU.

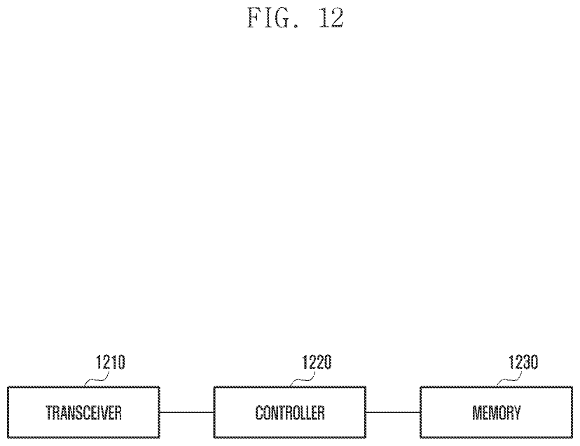

FIG. 12 is a block diagram of a base station according to an embodiment of the disclosure.

Referring to FIG. 12, a base station includes a transceiver 1210, a controller 1220 and a memory 1230. The controller 1220 may refer to a circuitry, an ASIC, or at least one processor. The transceiver 1210, the controller 1220 and the memory 1230 are configured to perform the operations of the UE illustrated in FIGS. 1 to 10, or described above. Although the transceiver 1210, the controller 1220 and the memory 1230 are shown as separate entities, they may be realized as a single entity like a single chip. Or, the transceiver 1210, the controller 1220 and the memory 1230 may be electrically connected to or coupled with each other.

The transceiver 1210 may transmit and receive signals to and from other network entities, e.g., a terminal.

The controller 1220 may control the base station to perform functions according to one of the embodiments described above. For example, the controller 1220 controls the transceiver 1210 and/or memory 1230 to perform small data transmission and reception according to various embodiments of the disclosure.

In an embodiment, the operations of the base station may be implemented using the memory 1230 storing corresponding program codes. Specifically, the base station may be equipped with the memory 1230 to store program codes implementing desired operations. To perform the desired operations, the controller 1220 may read and execute the program codes stored in the memory 1230 by using at least one processor or a CPU.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
identifying that a small data transmission (SDT) procedure is initiated based on an uplink data of a radio bearer for which SDT is allowed;
transmitting, to a base station while in a radio resource control (RRC) inactive state, the uplink data, wherein the uplink data is integrity protected using an integrity key generated based on the initiation of the SDT procedure; and
receiving, from the base station, an RRC release message for terminating the SDT procedure.

2. The method of claim 1,
wherein, in case that criteria for a 4-step random access procedure are met, the uplink data is transmitted in a message 3 (MSG3) of the 4-step random access procedure, and
wherein, upon receiving a message including a contention resolution identity in response to the MSG3, at least one of an uplink SDT transmission or a downlink SDT reception is performed while the terminal remains in the RRC inactive state and until the RRC release message is received.

3. The method of claim 1,
wherein, in case that criteria for a 2-step random access procedure are met, the uplink data is transmitted in a message A (MSGA) of the 2-step random access procedure, and
wherein, upon receiving a success radio access response (RAR) in response to the MSGA, at least one of an uplink SDT transmission or a downlink SDT reception is performed while the terminal remains in the RRC inactive state and until the RRC release message is received.

4. The method of claim 1, wherein a message including the uplink data further includes an RRC resume request message.

5. The method of claim 1, wherein at least one radio bearer for which the SDT is allowed is indicated from the base station on a per radio bearer basis.

6. A method performed by a base station in a wireless communication system, the method comprising:
receiving, from a terminal in a radio resource control (RRC) inactive state, uplink data of a radio bearer for which small data transmission (SDT) is allowed, wherein the uplink data is integrity protected using an integrity key generated based on an initiation of an SDT procedure; and
transmitting, to the terminal, an RRC release message for terminating the SDT procedure.

7. The method of claim 6,
wherein, in case that criteria for a 4-step random access procedure are met, the uplink data is received in a message 3 (MSG3) of the 4-step random access procedure, and
wherein, upon transmitting a message including a contention resolution identity in response to the MSG3, at least one of an uplink SDT transmission or a downlink SDT reception is performed while the terminal remains in the RRC inactive state and until the RRC release message is transmitted.

8. The method of claim 6,
wherein, in case that criteria for a 2-step random access procedure are met, the uplink data is received in a message A (MSGA) of the 2-step random access procedure, and
wherein, upon transmitting a success radio access response (RAR) in response to the MSGA, at least one of an uplink SDT transmission or a downlink SDT reception is performed while the terminal remains in the RRC inactive state and until the RRC release message is transmitted.

9. The method of claim 6, wherein a message including the uplink data further includes an RRC resume request message.

10. The method of claim 6, wherein at least one radio bearer for which SDT is allowed is indicated to the terminal on a per radio bearer basis.

11. A terminal in a wireless communication system, the terminal comprising:
a transceiver configured to transmit and receive a signal; and
a controller coupled with the transceiver and configured to:
identify that a small data transmission (SDT) procedure is initiated based on an uplink data of a radio bearer for which SDT is allowed,
transmit, to a base station while in a radio resource control (RRC) inactive state, the uplink data, wherein the uplink data is integrity protected using an integrity key generated based on the initiation of the SDT procedure, and
receive, from the base station, an RRC release message for terminating the SDT procedure.

12. The terminal of claim 11,
wherein, in case that criteria for a 4-step random access procedure are met, the uplink data is transmitted in a message 3 (MSG3) of the 4-step random access procedure, and
wherein, upon receiving a message including a contention resolution identity as a response to the MSG3, at least one of an uplink SDT transmission or a downlink SDT reception is performed while the terminal remains in the RRC inactive state and until the RRC release message is received.

13. The terminal of claim 11,
wherein, in case that criteria for a 2-step random access procedure are met, the uplink data is transmitted in a message A (MSGA) of the 2-step random access procedure, and
wherein, upon receiving a success radio access response (RAR) in response to the MSGA, at least one of an uplink SDT transmission or a downlink SDT reception is performed while the terminal remains in the RRC inactive state and until the RRC release message is received.

14. The terminal of claim 11, wherein a message including the uplink data further includes an RRC resume request message.

15. The terminal of claim 11, wherein at least one radio bearer for which SDT is allowed is indicated from the base station on a per radio bearer basis.

16. A base station in a wireless communication system, the base station comprising:
a transceiver configured to transmit and receive a signal; and
a controller coupled with the transceiver and configured to:
receive, from a terminal in a radio resource control (RRC) inactive state, uplink data of a radio bearer for which small data transmission (SDT) is allowed, wherein the uplink data is integrity protected using an integrity key generated based on an initiation of an SDT procedure, and
transmit, to the terminal, an RRC release message for terminating the SDT procedure.

17. The base station of claim 16,
wherein, in case that criteria for a 4-step random access procedure are met, the uplink data is received in a message 3 (MSG3) of the 4-step random access procedure, and
wherein, upon transmitting a message including a contention resolution identity in response to the MSG3, at least one of an uplink SDT transmission or a downlink SDT reception is performed while the terminal remains in the RRC inactive state and until the RRC release message is transmitted.

18. The base station of claim 16,
wherein, in case that criteria for a 2-step random access procedure are met, the uplink data is received in a message A (MSGA) of the 2-step random access procedure, and
wherein, upon transmitting a success radio access response (RAR) in response to the MSGA, at least one of an uplink SDT transmission or a downlink SDT reception is performed while the terminal remains in the RRC inactive state and until the RRC release message is transmitted.

19. The base station of claim 16, wherein a message including the uplink data further includes an RRC resume request message.

20. The base station of claim 16, wherein at least one radio bearer for which SDT is allowed is indicated to the terminal on a per radio bearer basis.
